(19) United States
(12) Patent Application Publication
(10) Pub. No.: US 2014/0317000 A1
(43) Pub. Date: Oct. 23, 2014

(54) SYSTEM AND METHOD FOR MANAGEMENT OF A PATENT PORTFOLIO

(71) Applicants: Steven W. Lundberg, Edina, MN (US); Lars Olof Hugo Svensson, Plymouth, MN (US); Peter W. Rebuffoni, Minneapolis, MN (US); Tyler L. Nasiedlak, Edina, MN (US); Jill D. Young, Minneapolis, MN (US); Piers A. Blewett, Milton, GA (US); Joseph R. Williams, Eden Prairie, MN (US)

(72) Inventors: Steven W. Lundberg, Edina, MN (US); Lars Olof Hugo Svensson, Plymouth, MN (US); Peter W. Rebuffoni, Minneapolis, MN (US); Tyler L. Nasiedlak, Edina, MN (US); Jill D. Young, Minneapolis, MN (US); Piers A. Blewett, Milton, GA (US); Joseph R. Williams, Eden Prairie, MN (US)

(21) Appl. No.: 14/257,118

(22) Filed: Apr. 21, 2014

Related U.S. Application Data
(60) Provisional application No. 61/814,073, filed on Apr. 19, 2013.

(51) Int. Cl. G06Q 50/18; G06Q 10/06

(52) U.S. Cl. CPC G06Q 50/184; G06Q 10/06
USPC 705/310

(57) ABSTRACT

Generally discussed herein are systems and methods for performing patent analytics. In one or more embodiments, a method for performing patent analytics can include receiving an identification of a target patent, analyzing the target patent to determine a corpus of prior art references cited against the target patent, classifying a plurality of the references in the corpus of prior art references as abandoned or active, generating a value rating for the target patent based in part on the classifying, or storing the value rating in association with the target patent.

### RELATED APPLICATIONS

This application claims priority to U.S. Provisional Patent Application Ser. No. 61/814,073, filed Apr. 19, 2013, the contents of which are incorporated herein by reference in their entirety.

This application includes subject matter related to U.S. Provisional Patent Application Ser. No. 61/542,515, filed Oct. 3, 2011, U.S. Provisional Patent Application Ser. No. 61/561,502, filed Nov. 18, 20111, and U.S. Provisional Patent Application Ser. No. 61/691,182, filed Aug. 20, 2012; the contents of all of the related applications are incorporated herein by reference in their entirety.

### BACKGROUND

The management of a patent portfolio involves multiple stages. Initially, a decision is made as to what inventions are worth the investment of filing a patent application. Then, each filed patent application goes through prosecution with the patent office. Finally, for each patent that is allowed, maintenance fees must be paid at a variety of intervals to keep the patent in force.

### BRIEF DESCRIPTION OF DRAWINGS

Some embodiments are illustrated by way of example and not limitation in the figures of the accompanying drawings in which:

FIG. 1 is a system component diagram, according to an example embodiment.

FIG. 2 is a block diagram of a patent management system, according to an example embodiment.

FIG. 3 is a user interface, according to an example embodiment.

FIG. 4 is a flow diagram of a method of valuing a patent document, according to an example embodiment.

FIG. 5 is a flow diagram of a method of determining a claim scope rating, according to an example embodiment.

FIG. 6 is a flow diagram of a method of determining a similarity score between patent documents, according to an example embodiment.

FIG. 7 is a flow diagram of a method of determining a significance of a patent document, according to one or more embodiments.

FIG. 8 is a block diagram of machine in the example form of a computer system within which a set instructions, for causing the machine to perform any one or more of the methodologies discussed herein, may be executed.

### DETAILED DESCRIPTION

The life cycle of a patent may include multiple stages. These stages generally include invention, filing a patent application on the invention, prosecuting the patenting application to allowance or abandonment, determining whether to file any continuing applications, and paying maintenance fees on the allowed patent.

At each stage, one or more parties determine the best course of action to take with respect to the invention. For example, when determining whether or not to file a patent, the inventor may know what products are out in the technology area of the invention, a business manager may know how the invention fits in with a company's goals, and a patent attorney may have researched existing patents or application in the technology area of the patent. These parties will ultimately make the decision whether it is worth the initial investment of filing an application on the invention and then at each future stage determine the next course of action.

In various embodiments, a patent management system includes tools to help the parties involved in the patenting process make decisions at each stage of a patent's life. These tools may also be used for general research by parties not immediately involved with the patenting of the invention. Additionally, these tools may be used as standalone tools, in combination with other tools, and in combination with other patent management systems. Examples of tools include, but are not limited to prosecution analytics, reference management, prior art analytics, docketing management, claim mapping, claim analytics, portfolio analytics, annuity management, market analysis, user interfaces, and strategic monitoring.

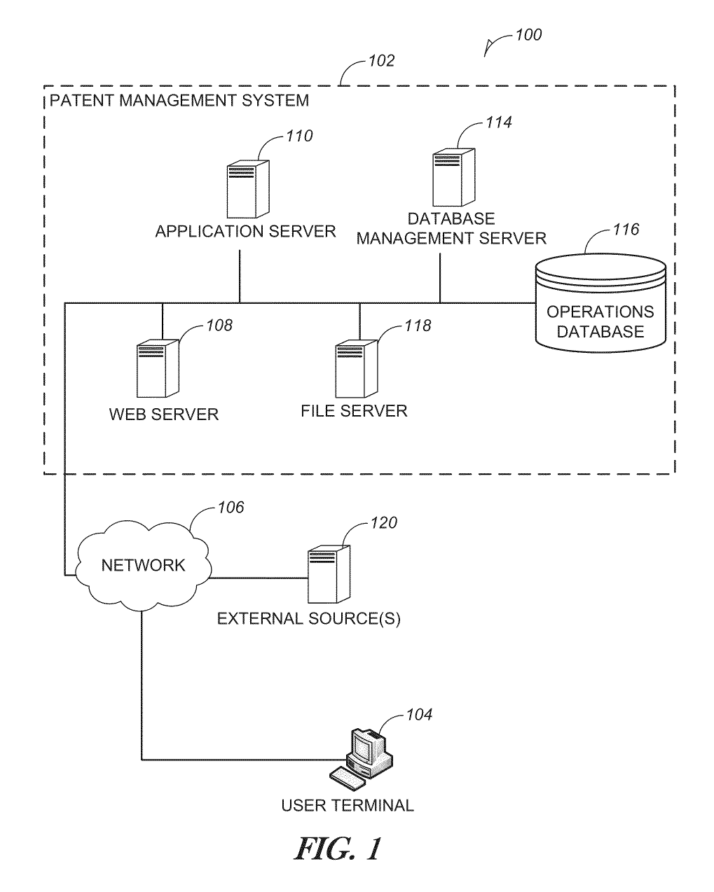

FIG. 1 is a schematic view of computer network system 100 according to various embodiments. The computer network system 100 includes patent management system 102 and user terminal 104 communicatively coupled via network 106. In an embodiment, patent management system 102 includes web server 108, application server 110, database management server 114, which may be used to manage at least operations database 116 and file server 118. Patent management system 102 may be implemented as a distributed system, for example one or more elements of the patent management system 102 may be located across a wide-area network from other elements of patent management system 102. As another example, a server (e.g., web server 108, file server 118, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based applications and presentation of information. For example, application server 110 may consist of scripts, applications, or library files that provide primary or auxiliary functionality to web server 108 (e.g., multimedia, file transfer, or dynamic interface functions). Applications may include code, which when executed by one or more processors, run the tools of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in patent management system 102, may provide a user-interface to user terminal 104 for interacting with the tools of patent management system 102 stored in application server 110. The user-interface may be implemented using a variety of programming languages or programming methods, such as HTML (HyperText Markup Language), VBScript (Visual Basic® Scripting Edition). JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 104 may be a personal computer or mobile device. In an embodiment, user terminal 104 includes a client program to interface with patent management system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a compilation, represent an “operations database.” Sub-databases in such a configuration may include a matter database a portfolio database, a user database, a mapping database and an analytics. In various embodiments, additional databases are utilized for one or more of the patent tools. Operations database 116 may be implemented as a relational database, a centralized database, a distributed database, an object oriented database, or a flat database in various embodiments.

In various embodiments, the tools of the patent management system share a common framework. The framework may have a base organization unit of a matter. In various embodiments, a matter is an issued patent or patent application that includes one or more patent claims. In an embodiment, a matter is generally identified by its patent number or publication number. Identification may mean either identification as it relates to a user of the patent management system or within the patent management system. Thus, a user may see a matter listed as its patent number while internally a database of the patent management system may identify it by a random number. One or more matters may be associated with prior art or cited references stored in a reference or prior art database.

One or more matters may be grouped together to form a portfolio. A matter may also be associated with one or more other matters in a family. A family member may be a priority matter, a continuing (e.g., continuation, divisional) matter, or foreign counter-part member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various embodiments, a matter may be associated with more than one portfolio by creating multiple entries in the portfolio database, one for each portfolio the matter is associated with. In other embodiments, one or more patent reference documents may be associated with a patent by creating multiple entries in the patent database, for example. The structure of the database and format and data field titles are for illustration purposes and other structures, names, formats may be used. Additionally, further associations between data stored in the databases may be created as discussed further herein.

During operation of patent management system 102, data from multiple data sources (internal and external) is imported into or accessed by the operations database 116. Internal sources may include data from the various tools of the patent management system. External sources 120 may include websites or databases associated with foreign and domestic patent offices, assignment databases, WIPO, INPADOC, and law firm databases. In various embodiments, the data is scraped and parsed from the websites if it is unavailable through a database. The data may be gathered using API calls to the sources when available. The data may be imported and stored in the operations database on a scheduled basis, such as weekly, monthly, quarterly, or some other regular or periodic interval. Alternatively, the data may be imported on-demand.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats).

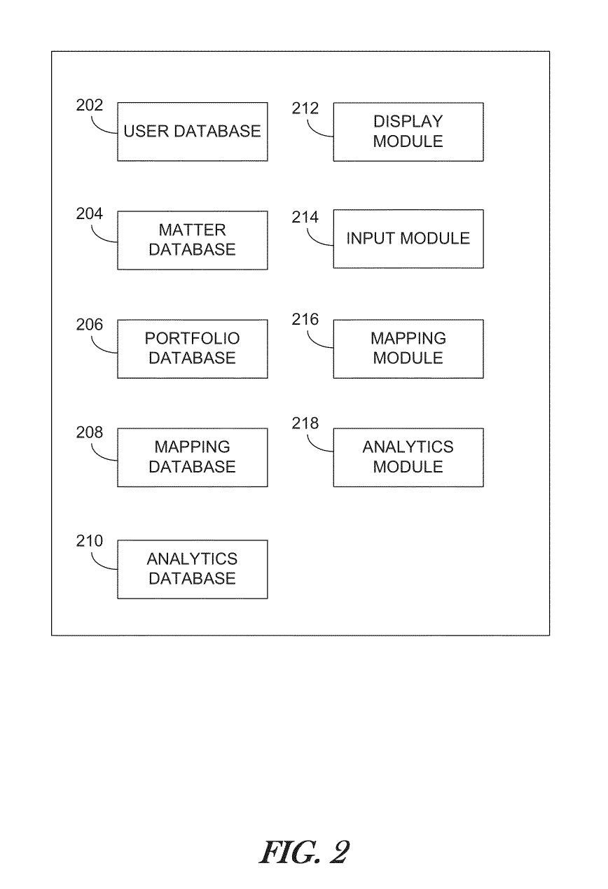

FIG. 2 is a block diagram of patent management system 102, according to an example embodiment. Illustrated are user database 202, matter database 204, portfolio database 206, mapping database 208, analytics database 210, display module 212, input module 214, mapping module 216, and analytics module 218. Additional or fewer modules may be utilized in implementing functionality of one or more of the patent tools. In various embodiments, the data stored in databases 202, 204, 206, 208, and 210 may be in the same or multiple physical locations. For example, portfolio database 206 may be stored in one or more computers associated with a portfolio management service. In various embodiments, patent management system 102 mirrors databases stored in other locations. In an embodiment, when a request is made to access data stored in the databases, patent management system 102 determines where the data is located and directs the request to the appropriate location. Similarly, modules 212-218 may be executed across multiple computer systems.

In an example embodiment user database 202 stores data representing users of patent management system 102. The data may include data fields of user credentials including a user ID and password and access rights with respect to patent management system 102. The user ID may be a common across the tools of the patent management system. In this manner, access rights of the user with respect to the tools of the patent management system may follow across the various tools of the patent management system. In an example embodiment, different access rights are granted to a user if) between the various tools.

In various embodiments, each user ID has access rights to one or matters. Similarly, a user if) may have portfolio level access rights. Access rights may be defined according to at least two parameters: read access and write access. Thus, when a user logs into patent management system 102, the user is presented with access only to the matters/portfolios that have been associated with the user ID. More (e.g., additional contact information) or fewer data fields associated with a user may be included in a user entry stored in user database 202.

In an embodiment, matter database 204 stores data representing matters. Each matter may be associated with one or more portfolios as well. In some embodiments, a matter is associated with no portfolios. In various embodiments, a matter is a foreign or domestic patent or application. Matters may also be inventions that have not yet been filed (e.g., as may be the case within a docketing system). In an embodiment, a matter entry includes data fields representing a matter ID, patent number, publication number, serial number, docketing number, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, inventors of the matter, current owner of the matter, cited references on the face of the matter, filed date, issue date, docket number, and annuity information (e.g., due date, country, and amount due). In some embodiments, other patent reference documents or prior art in any form may be stored and associated with one or more matters. More or fewer data fields associated with a patent may be included in a matter entry stored in matter database 204. In an example embodiment, matter database 204 may store a patent matter database, wherein this database includes data about the patent matters. The data may include for at least one patent matter a claim set or statement of invention and a priority date for the claim set or statement of invention. Matter database 204 may also store a database of prior art documents (also known as “references”), wherein the prior art database includes data about the prior art documents. The data may include for at least one prior art document a priority date or publication date of the document. One or more of the prior art documents may be associated with a first patent matter in the patent matter database.

In various embodiments, a matter is associated with one or more other matters as a family with a family II). Family members may be priority documents, continuation patents/applications, divisional patents/applications, and foreign patent/application counterparts. In an embodiment, family information is determined according to an external source such as INPADOC. Patent reference documents and/or other prior art may be manually or automatically stored, cross-cited and associated with related family matters, for example.

Portfolio database 206, in an example embodiment, stores data representing portfolios of one or more matters. Data stored in portfolio database 206 may have been previously generated by a tool of patent management system 102. In various embodiments, a portfolio may be generated by a user using patent management 102. For example, a user interface may be presented to the user requesting a name for the portfolio and identifiers of matters to be included in the portfolio. In an embodiment, a portfolio entry in portfolio database 206 includes data fields of portfolio ID and portfolio name. Additionally, a data field for matter ID may also be included in an entry in the portfolio database. Thus, each portfolio may be associated with one or more matters through the use of the matter ID data field. More or fewer data fields associated with a portfolio may be included in a portfolio entry of portfolio database 206.

In an example embodiment, mapping database 208 includes mappings of scope concepts, technology categories, and keywords to one or more matters. In an embodiment, a scope concept is a textual description of what a patent claim is at least limited to. Thus, if a claim comprises A, B, & C a scope concept may be A. In various embodiments, a scope concept for the claim may be broader than A because the claim will still be limited to the broader scope concept. In an embodiment, the mapping database stores mappings between claims and scope concepts. A technology category mapping may indicate a claim is in a certain technology area. A keyword mapping indicates may indicate that there is an exact match between the keyword and a subset of the claim language.

In various embodiments, analytics database 210 stores data representing calculated analytics on data stored within patent management system 102 or external data sources. In various embodiments, analytics are organized according to an individual matter, a portfolio, or family. The calculated analytics may be based on information gathered from multiple sources such as databases of patent management system 102 and PAIR.

In various embodiments, information for an individual matter may include status (e.g. disclosure received, drafting, filed, completed-waiting examination, in prosecution, allowed, issued), cited prior art, list and type of rejections (e.g., 35 U.S.C. §101, 102, 103) number of claims allowed, office action count, interviews held, IDS statements filed, attorney fees to date, and PT( ) fees to date. Further metrics for an individual matter stored in analytics database 210 may include, time waiting for examiner, total time in examination, time waiting for PTO while in examination, time on appeal. Additional prosecution details formatter may include an upcoming docket dates (e.g., due dates for office action, IDS due dates, etc.). A claim prosecution history chart may also be stored in analytics database 210 for each matter. The prosecution history may include a history of claim amendments and arguments made in prosecution.

In various embodiments, portfolio and family analytics information may be stored in analytics database 210 based on aggregating the metrics for an individual matter. In an embodiment, the analytics of a family may differ from those in a portfolio as not all family member matters may be part of a portfolio. Additionally, the analytics may be stored for multiple time periods such that comparisons may be made between metrics currently and metrics a year ago (or other time period).

Aggregated metrics may include a total patents and applications, pending and waiting for examination, in prosecution with no claims allowed, in prosecution with some claims allowed, appealed, notice of allowance received, and issued. These metrics may be compiled for both US and international matters in the portfolio. Additional information may include the international portfolio distribution by country. An age distribution of the portfolio may also be compiled. For example the portfolio may be broken down by less than one year old. 1 to 3 years old. 3 to 5 years old, 5 to 10 years old, 10 to 20 years old, and 20 or more years old. Recent filing and issue activity as well as upcoming Ford filing deadlines may be stored in analytics database 210.

In various embodiments, prosecution metrics across a portfolio or family are determined and stored in analytics database 210. This data may include matters waiting for examination, matters in examination, matters appealed, and cases allowed but not yet issued. Analytics with respect office actions may also be compiled and stored. For example success of allowance after a first office action response, a second response, etc., may be stored in analytics database 210. Additional prosecution analytics may include allowance rate (e.g., 10%) after a telephone interview, allowance after an in-person interview, percentage of interviews with response, number and type of rejection, average time in prosecution (e.g. in months), average time to file a response, and average time to next office action. Further, the list of recently allowed cases, recently appeal cases, stalled cases, and recently abandoned cases may also be stored for each portfolio and family in analytics database 210.

In various embodiments, the results of keyword analysis on one or more matters and/or prior art references may be stored in analytics database 210. The keyword analysis may be based on the occurrences of the keywords in the matter or references to derive a score or keyword overlap.

In various embodiments, data stored in the database for group of matters in a portfolio or family is analyzed to determine the top (e.g., ten) most cited patents, the top most cited inventors, top most cited prior art owners (e.g., according to assignment documents or the face of the patent), newly (e.g., within the last 60 days) cited prior art owners, and top most cited prior art inventors. This information may be stored in analytics database 210.

In an embodiment, display module 212 is configured to display user interfaces and information retrieved from one or more databases 202-210. If a user is accessing patent management system 102 remotely (e.g., through a web browser) display module 212 may be configured to transmit data representing a user-interface through a network to a user terminal. In various embodiments, display module 212 is configured to generate one or more charts of data stored in databases 202-210. For example, display module 212 may generate a pie chart of the top 10 inventors within a portfolio.

In various embodiments, input module 214 receives data from multiple sources where it may be further processed by one or more other modules and stored in one or more of databases 202-210. For example, input module 214 may be configured to utilize one or more APIs to data from one or more patent data stores (e.g., public PAIR, private PAIR, INPADOC, foreign patent offices, patent docketing systems, portfolio management systems, etc.). The data may include published patent documents, patent applications, office actions or other patent office correspondence, prior art references, claim mappings, dockets dates, and annuity payment data.

In various embodiments, input module 214 is configured to receive input from one or more user interface elements. For example patent management system 102 may present multiple user interfaces to a user. These user interfaces may enable users to input data directly into databases 202-210, instruct the patent management system to retrieve data from patent data stores, and instruct the patent management system to perform various operations (e.g., analysis) on the data in databases 202-210.

Additionally, input module 214 may be configured to determine the selection of one or more user interface elements by a user and initiate the action associated with the selected user interface element. For example, a user interface element may include a drop-down menu to select a portfolio. Input module 214 may be configured to receive the selection of the portfolio by the user. Then, input module 214 may pass the selection to one or more other modules for further processing. For example, display module 214 may update the drop-down menu to indicate the selection of the portfolio.

In various embodiments, input module 214 processes the data that has been inputted and formats it according to the data fields of databases 202-210 as discussed above. Is various embodiment processing is completed using a parsing module (not shown). For example, consider a patent publication that a user has directed to be inputted into one or more of the databases. The processing module may use a combination of automatic image recognition and text analysis to determine the filing date, issue date, title, abstract, and claims of the patent. In some embodiments, the parsing module may flag certain pieces of data that had been determined to be potentially inaccurate (e.g., a number could not be read). A user of patent management system 102 may then examine the flagged data and manually enter the information which is then stored in the appropriate database.

The resulting data that has been parsed by the parsing module may then be entered as an entry in one or more of databases 202-210. This may be accomplished by, for example, formulating an insert SQL query with the parsed information. In various embodiments the parsing module may parse multiple piece of information before generating a database entry. For example, input module 214 may receive a docket number for an issued patent. The docket number may be combined with the information parses from the issued patent to form an entry in matter database 204.

In various embodiments, mapping module 216 is configured to facilitate mappings of scope concept, technology categories, and keywords to patent claims of a matter. In an embodiment, mapping signifies association. For example, in conjunction with display module 212 and input module 214, mapping module 216 may present a user interface of patent claims stored in matter database 204 and scope concepts stored in mapping database 208. Input module 214 may receive a selection of one or more patent claims and one or more scope concepts and pass them to mapping module 216. Mapping module 216 may then formulate an SQL query to associate the one or more patents claims with the one or more scope concepts. When executed, the SQL query, may update the mapping database 208 with the associations. In various embodiments, mapping module 216 also allows the creation of new scope concepts, technology categories, and keywords that may be mapped to one or more patent claims. Furthermore, mapping module may present user interfaces that allow a user to rank and rate matters stored in matter database 204.

Mapping module 216 may also allow the generation of claim charts of a plurality of cells. A claim chart may include one or more scope concepts, technology categories, and keywords on one axis and claims of matters in a portfolio on the other axis. The claim chart may include a variety of levels of granularity of scope concepts. Some claims may be mapped to all of the scope concepts while others may not be mapped to any scope concepts. At the cell intersection between a scope concept (or technology category or keyword) and a claim an indication of the mapping may be presented by changing the format of the cell. For example, the cell may be colored blue when a scope concept is mapped and red when not mapped.

In various embodiments, analytics module 218 is configured to examine and run calculations on the data stored in the databases 202-210 to generate the analytics discussed previously. For example, analytics module 218 may formulate an SQL query that retrieves the number of times that a prior art reference has been cited within a portfolio. This query may be run for each prior art cited within the portfolio to determine a list of the most cited (e.g., the top ten) prior art references with a portfolio. In an embodiment, the queries are formulated and run as requested by a user. In an embodiment, once the analytics information has been determined, it is stored within analytics database 210. In various embodiments, queries are formulated and run on a periodic basis (e.g., nightly) and entries in analytics database 210 may be updated to reflect any changes.

In various embodiments, the analytics module 218 is configured to receive input identifying a pool of keywords for a first patent matter in matter database 206 and associated prior art documents in matter database 206. The term keyword is intended to include individual keywords as well as a number of keywords grouped together making up a key phrase, for example. The module 218 may be further configured to perform a keyword analysis on the first patent matter and associated prior art documents based on occurrences of the keywords in the first patent matter and associated prior art documents. The module 218 may be further configured to identify, based on the analysis, keywords occurring uniquely in the first patent matter. In view of their uniquely occurring nature, these keywords may be regarded as claim elements potentially differentiating the claim set or statement of invention over the disclosures contained in the one or more prior art documents.

In various embodiments, a filtering module is configured to filter a set of matters according to a user preference. For example, a user may activate a check box that indicates only pending matters should be shown in a user interface. The filtering module may formulate a query consistent with retrieving only pending matters. The results of the query may then be shared with display module 212 where the user interface may be updated.

In various embodiments, a payment module is configured to receive selections by the user of which annuities to pay for matters in a portfolio. Additionally, the payment module may receive user preferences related to the payment of the annuities. The payment module may receive payment information from a user and forward the payment information to the appropriate agency/office. In some embodiments, annuity management system 102 organizes payment of the annuity on behalf of the user and the user pays annuity management system 102.

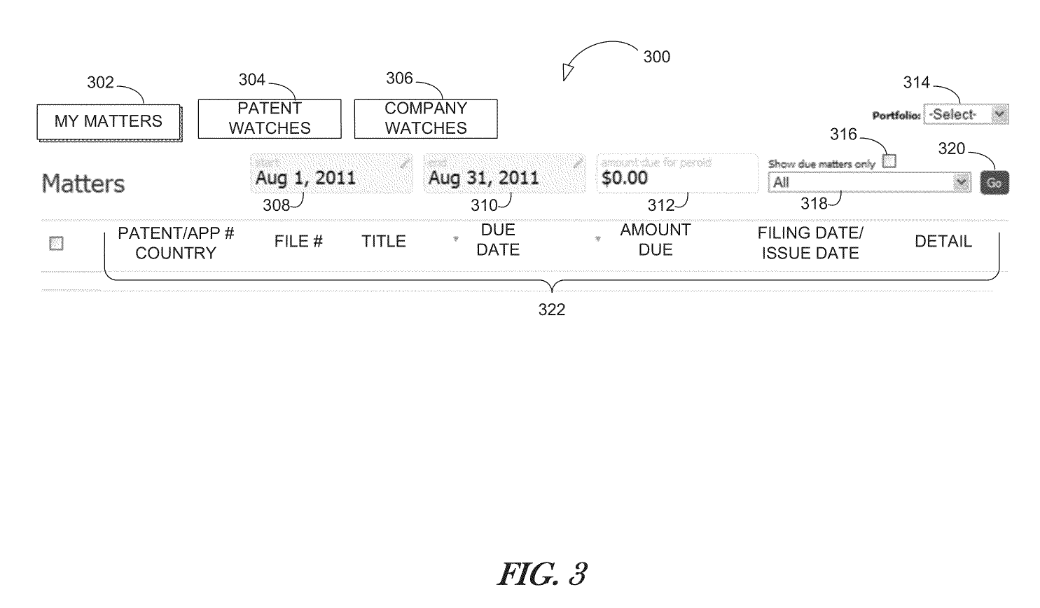

FIG. 3 is an example user interface 300 of patent management system 102 which may be used to facilitate the methods, tools and systems described herein. User interface 300 is illustrated with multiple user interface elements. In an example embodiment, a user interface element is a graphical or textual element that a user may interact with to cause an application to perform an assigned action for the interface element. Data representing user interface 300 may be transmitted via network 106 and presented on a display of user terminal 104 through the use of a web browser. A user (e.g., manager of a patent portfolio) may interact with the user interface elements of user interface 300 through the use of an input device (e.g. stylus, cursor, mouse, finger) of the user terminal. In an embodiment, a user selection is based on the coordinates of the input device as it makes contact with the display or where a user “clicks” the mouse. The coordinates are compared to the coordinates of the user input element to determine the selection. The type of user elements, names, and layout depicted in FIG. 3 are intended to be an illustration of an example user interface of patent management system 100. Other types of user elements, names, and layouts may be used.

The user interface elements may include my matters 302, patent watches 304, and company watches 306. These elements may be used to select a context/view of the patent management system. For example, my matters lists the patents included within a portfolio of a user, patent watches lists information on patents that the user has indicated the patent management system is to watch, and company watches lists information on companies that the user has indicated the system should watch. Further details of each of these included herein.

Date boxes 308 and 310 are user elements that allow a user to select a time period. Amount due box 312 displays the amount due with respect to annuities for patents in the portfolio of the user within the period indicated by date boxes 308 and 310. Upon activating (e.g., clicking) one of the date boxes, a user may be presented with a calendar which allows the selection of a date. Upon selecting a date, the date boxes will update to reflect the user's choice.

Drop-down menu 314 includes a list of portfolios that a user of the patent management system is authorized to view. For example, before user interface 300 is displayed, a login screen may be presented to the user which requests a user ID and password. In various embodiments, the user ID is associated with one or more portfolios. In turn, each portfolio is associated with one or more matters. Matters may include US and foreign issued patents, pending patents, abandoned patents, and not yet filed applications. Thus, upon selection of a portfolio using drop-down menu 314, user interface 300 is populated with matters associated with the portfolio.

Checkbox 316 is an option to only display matters that currently have an annuity due. Drop-down menu 318 allows further filtering of matters. For example the matters may be filtered by US patents only, US patent applications, and foreign only.

In various embodiments, activation of button 320 updates user interface 300 to reflect the choices made by the user with respect to date boxes 308 and 310, checkbox 316, and drop-down menu 318. For example, amount due box 312 will be updated to reflect the amount due within the new period and the matters listed under column headings 322 may be filtered. In various embodiments, user interface 300 is updated as the user selections are made with respect to elements 308 to 318 without activating button 320.

Prosecution Analytics

Various tools may be implemented using the system described above. Some of the tools are described below.

In various embodiments, a software tool to collect and present prosecution analytics may be used with patent management system 102. For example, a dashboard may be displayed for each matter in a user's portfolio to give specific information for the matter or overall portfolio metrics. For each matter the dashboard may include docket dates as well as analytics listed below.

In various embodiments, analytics including success rate(s) of responses based on the following:
a. Probability a response will result in allowance or other event;
   i. Responses of different types, e.g. non-final, final, after final;
   ii. Based on class/subclass;
   iii. Based on examiner;
   iv. Based on art unit;
   v. Based on number of prior responses;
   vi. Based on how long the case has been in active prosecution;
b. Analytics—success rates based on USPTO statistics or Attorney or Attorney Organization data;
   i. Probabilities of 2 for each—USPTO vs. Attorney vs. Attorney Org;
   ii. Compare both;
c. Analytics—success rates based on Owner of Patent/Invention;
d. Analytics—success rate based on type of owner—e.g., small or large entity;
e. Analytics—success rates based on Prior Art Owners;
f. Analytics—success rates based on length of claim;
g. Analytics—success rates based on number of words added to claim;
h. Analytics—success rates based on length of arguments;
i. Analytics—success rates based on type of rejection;
j. Analytics—success rates based on effective date of prior art; and
k. Analytics—success rate based on keyword/key phrase overlap between prior art and application specifications

In an embodiment, additional analytics are displayed to a user based on analytics in PAIR like system (sometimes referred to as PAIR Plus): statistics for examiner; supervisor; statistics for art unit; statistics for class/subclass; and analytics on the prior art.

In various embodiments, prosecution Analytics are generated from PAIR and combined with information in an existing file management (e.g., docketing) system. The analytics may be combined to generate portfolio prosecution Analytics. Success rates may be checked based on results (e.g., correlate to attorneys and examiners).

In various example embodiments, a tool may be used to scrape PAIR references into prior art in matters. In some example embodiments, it may automatically cross-cite.

In some example embodiments, a tool may be used to: 1. Read PAIR; 2. See what new references add to prior art; 3. Examine the office action to find the grounds for rejection near the reference from the list.

In various example embodiments, a tool may present a claim chart matrix in which there is one column per PTO action; top of column each applied reference is listed in rows and denoted, for example, A, B, C; Each row below is claim and code for rejection type and reference.

In some example embodiments, a prosecution analytics software tool may scrape data from an office action into a portfolio. The patent claims may be entered in the “matters” list, and references may be entered in the “references” list. In some example embodiments, the art may be auto analyzed. In one example embodiment, a wizard may be provided to analyze the art. The tool may put links to pertinent law/rules. Analytics may be generated for each reference and/or era of references. In some example embodiments, the software tool may send a link to the portfolio to an attorney.

In various example embodiments, a tool may, for any given patent, show a forward citation timeline, where the tool may include: i. a timeline with a bar for each year the patent is forward cited (based on filing date of the forward cited patent); ii. each bar has a segment for each patent for that year (e.g., two segments for two forward cites in a year); and iii. each segment is “heat map” color coded based on—1) if citation was “applied” and 2) keyword overlap in technical field, abstract, claims. In some example embodiments, the tool may show a forward citation, where the tool may place all forward cites along the x axis and expand the graph downwardly for forward cites of the forward cites. In some example embodiments, this creates a two dimensional chart. In certain example embodiments, the forward cites of forward cites could be added in the same way as the forward cites to show growth in activity in an area.

Reference Management

In various embodiments, tools for prior art management are used in patent management system 102. In an embodiment, in a matter management system (e.g., patent management system 102), there us a cross-citation control panel for citing prior art between cases. In various embodiments, the control panel:
i. shows all cases to “send” art to or “receive” art from or both;
ii. allows user to set rules for sending or receiving based on;
   a. Number of time art has hopped already to get to the matter;
   b. Type of citation—102(b)/103;
iii. Cases to send or receive from may be automatically populated by family matters or other matters.
   The tool may also show citations pathway for each reference:
a. Where it started;
b. What it flowed through;

In various embodiments, a prior management portfolio may be created by that has features of:

a. Loading Matters (pending or issued apps) into special “prior art management” portfolios;

b. Art automatically flow between Matters in a portfolio;

c. Art flows between portfolios via Matters listed in more than one portfolio;

d. Art is kept in list in Portfolio;

e. Not based on patent family or related cases necessarily—any arbitrary cases may be added;

f. Art displayed in each Matter may be filtered by:
i. Cross-cited art (art arriving from other Matters);
   1. Number of hops to get to list;
   2. Type of rejection (102/103);
   3. Other analytics—see e.g., prior art analytics;
   4. New art added to Portfolio;

g. Art may be added to Portfolio, in the Prior Art (called “references”) list;
i. This art is not cross cited to other Matters in other portfolios until it is added first to a Matter to be cited or as cited;
ii. This art is displayed for each Matter to be considered, as “new art” not yet cross-cited”

In various embodiments, PAIR Plus may include:

a. Pair data;

b. Uncited art cross-reference;

c. Links to cases beyond PAIR;

d. Scanned docs;

e. Art analysis;

f. Art highlights;

g. Analytics with Actions;

h. Foreign cases;

i. Docket Dates for Matter—calculated by PAIR PLUS;

j. PAIR Process Options—process options for any given point in a case

k. Foreign PAIR; a. Aggregate of US and foreign PAIR

In various embodiments, PAIR Plus may also automatically proof claims, scan amendments, assemble most recent claims, compare to issued patent, scan prior art, make a list of prior art, and compare it to the issued patent. Differences may be determined between the filed specification and issued specification. The differences may be presented to a user for review.

Prior Art Analytics

In various embodiments, a tool for analytics of prior Art includes:
a. Automatic keyword/key phrase differentiation;
   i. Create pool of keyword/key phrases for prior art and for pending application;
   ii. Note differentiating keyword/key phrases;
b. Automatic prior art ranking based on keyword/key phrase overlap;
   i. Art with most keyword/key phrase overlap is highest ranked;
   ii. Allow manual addition of synonyms to enhance analysis;
c. Prior art timeline graphs;
   i. Show timeline with dates of prior art vs. application;
   ii. Show timeline of all patents or applications in class/subclass, in comparison to pending application;
d. Keyword/key phrase timeline graphs;
   i. Show timeline of when keyword/key phrases of application first appeared in prior art;
   ii. Could be table/chart with keyword/key phrases listed by order of appearance by year, with representation of each year; and
e. Dominance of owners by keyword/key phrase—show which owners own most art with matching terminology (also for payment analytics).

In various embodiments, an analytics tool may be used to determine prior art overlap. For example, for example competitor overlap for single patent, portfolio, or family may be include:

a. prior art citation overlap;

b. overlap of prior art cited against Target Company's patent or portfolio, and prior art cited against Competitor Company or Companies, identified by user;

c. analytic result may include a list of prior art cited against both the Target and the Competitors;

d. analytic result may include list of companies that own prior art cited against Target and Competitors (e.g., show the number of references cited against both owned by Target).

In various embodiments, a process is used that: 1) looks at US patent and if it shows a reference was applied, get name of company it was cited against and highlight that company as a target for the applied reference; 2) for applied references, crawl PAIR and OCR or otherwise reverse engineer the reason reference was cited, and pull comments by PTO or attorney; and 3) take note if it was a §102 reference or §103. Then, in various embodiments, do the same for foreign references of PCT search. For example, determining if an applied reference was a 102/103 a tool may determine the name of the applied reference from the face of patent and then look for text “102” or “103” near the reference in the OCRd text, or like in foreigns.

An output may include a chart with headings of Prior Art Reference, #Cited against Target, and #Cited against Competitor 1, 2, 3 with example entries:

Reference A, [x], [y, z, a . . . ]

Reference B, [e], [b, c, d]

In various embodiments, a tool is used for prior art and forward reference citation analysis. The tool may generate a continuing stream of “watch results” for a single patent (or a group of patents). In an embodiment, there is a problem if an inventor or company sets up a watch to see if their patent is being cited by later-issued patents, many times no such cites occur for a long time, if at all. The tool helps produce a steady stream of watch results, on a daily/weekly/monthly basis. The tool may for: a. Forward cites of prior art: i. take the pool of all prior art cited on patent; ii. watch for forward cites of any of this art; iii. report these forward cites; b. Forward cites of applied prior art only: i. take pool of applied art cited on patent (USPTO puts asterisk on these); ii. watch for forward cites; iii. report these forward cites; c. Forward cites of patent being watched; i. this is prior art; d. Forward cites of forward cites; i. here we look at the forward cites of patent being watched; ii. report any forward cites of those references; e. Forward cites of forward cites of prior art. In various embodiments, the display of these results may be dynamically determined based on the number of results available by: a. for example, may want to suppress presentation of more remotely relevant watch results if there are plenty of more pertinent watch results; b. list results in order of perceived pertinence; i. forward cites of watched patent of course most relevant; ii. perhaps forward cites of applied art next most relevant; iii. then, perhaps, forward cites of forward cites; iv. then, perhaps, forward cites of any prior art reference; f) Also, the tool may filter watch results from the company that owns the patent—so if the owner of the watched patent cites back to it, the tool may provide an option to ignore those results.

In various embodiments, a prior art date analyzer is used to: a) In PAIR, using patent number, pull priority dates from PAIR or other source for US patent/application; and b) apply prior art rules to determine likely effective date of reference.

In an embodiment, an office action workroom tool is used for analyzing cited prior art. The analytics may include 1) owners of art, 2) timing of art—timeline view, 3) timeline of art in art unit/class-subclass, 4) notable inventors, and 5) keyword overlap—unique keywords for case under rejection. In an embodiment, the prior art has been prepared (e.g., using OCR) for search. Then, a list of keywords may be run against the cited prior art. In an embodiment, the tool may generate a spreadsheet output with keywords mapped to paragraphs with analysis functions built in spreadsheet or may generate a spreadsheet with capabilities built into a web interface. The capabilities may be used to find which paragraphs or documents have certain combinations of keywords (a user may pick the combination of keywords). Also, a user may search for and map concepts to cited art that are not shown. Prior art rejections may be mapped to specific paragraphs of document and shown in workroom or in a spreadsheet. Examiner statistics may also be part of the office action room, or examples of other rejections by examiner. Other rejections on the same references, or reference history, may be shown as well.

In various example embodiments, a tool for analyzing cited prior art may be used for forward and backward citation coverage list analysis. In some example embodiments, the tool may, for all patents of a first owner or patents in a class for an owner, 1) determine a list of all the other owners of patents or applications that own a patent that has been cited against the first owner, and how many for each; 2) determine a list of all the other owners of patents or applications that own a patent that one or more of the patents of the first owner have been cited against (e.g., forward cites), and how many for each; 3) determine and/or display the above (e.g., based on year), for example, in a chart with owners in rows and each year in a column; and 4) determine biggest gainers/losers (e.g., by year).

In various example embodiments, a prior art analytics tool may have features of:

1. Multi-level forward/backward citation search and presentation; or

2. Synonym/antonym FTO.

Docketing Management

In various embodiments, the PAIR Plus tool may include a docket verification-docket built in. For example: a) PAIR or portions thereof may be scraped or copied; b) in particular, transaction log or log of office actions; c) a docket engine that may be part of the tool; d) the docket engine may determine a set of docket dates—response due dates etc., e) due dates may also be for foreign filing or prior art cross citation; f) those dates are associated with or embedded into a PAIR document; g) user may download the PAIR document and the due dates are either on a PDF or on an Excel or XML or other form with document; h) or, user may synchronize their Outlook calendar with PAIR due dates; i) If the tool does not know the date, the tool may flag that and add to calendar or list of exceptions as an exception that needs to be looked at; j) or, there may be a PAIR docket system that users may subscribe to and get a docket that is driven directly off of PAIR—(e.g., the tool may check things off as done once filed in PAIR); ii. and the tool may docket a date that is not a response date (e.g., foreign filing or as noted above, IDS cross cites); k) the PAIR docket may also check other related matters, and docket for prior art cross-citation if system sees references cited in related case.

In various embodiments, to obtain some of the data above the tool may scrape or download PTO actions from foreign patent offices (either selectively or in bulk), OCR to get electronic data or reformat electronic other data downloaded, provide that electronic data to a user/operator of a docket system, and provide an import mechanism for the docket system, either as a BOT or through an API, to load docket information.

In various embodiments, another tool of PAIR plus may include automatically OCR of all PAIR does and provide word or PDF text doc versions of PTO does to PAIR plus user and/or using automatic text analysis, the tool may extract details/types of PTO actions as well as references. This then is added to the data set for the patent, and delivered in PAIR plus. In an embodiment, PAIR plus looks similar to the traditional USPTO site but with extra metadata.

In various embodiments, a tool is used to verify the accuracy of information for transferred in files as well as automating some of the entry of information for those files. For example the tool may search for an owner's name in international data, then picking additional matters to open from there, and automating the file entry. For example, the file type could be determined (e.g., PRV, ORG—which may or may not actually claim priority to another country—EPPAT, Non-PRV, CON/DIV. The tool may select the file type and automate the data entry after that. For example, the tool could also scan paperwork and OCR to extract key identifying information. The tool may get owner's name, pull a report from public PTO data that shows all of that owners files, and then have a user pick the file that matches the one they are opening. Additional data verification may include serial numbers and priority and filing dates from international patent databases, or US databases for US cases, in order to verify or even semi-automate entry of data for matter openings.

In various embodiments, a tool is used to set up goals and display progress towards those goals for a given period (e.g., quarter, year). The goals may include, number of new patent applications, number to issue, number of disclosures and, and number of defensive publications. The goals may also be separated out by country. A dashboard interface may display the goal and the current status (e.g., how m any patent applications have been filed). The interface may also include how many patent applications (or other goal metric) need to be filed per day/week in order to achieve the goals.

In various embodiments, a docketing management system may be improved in the following manner: 1) in the activity view, include a link that launches a calendar view of all milestone dates, with final dates highlighted, for example yellow for 5 months response date and red on 6 month response dates it red on foreign filing dates; 2) one of the above may be displayed for all activities or just one; 3) calendar may either be a monthly calendar with each day represented as a square, or monthly, with each month as a square but no daily detail, or yearly; 4) the other display mode may be a timeline mode; 5) for the timeline mode, each activity (process) may be represented as an individual horizontal line that has milestones and due dates for milestones and the corresponding dates of each horizontal line may be vertically aligned; 6) each activity/process may have a cost associated with it and the cost may be dependent on choices to be made for the process, like foreign filing, there may be a wizard that might for example launch process timelines for each contemplated foreign filing and the costs associated therewith; 7) projected costs for all processes are totalled on timeline to show timing of costs in the aggregate.

In an example implementation activity tasks/due dates are read and translated to Timeline format, and aligned in a timeline view of the case processes. Cost data for each activity may be kept and read to supply budget information. Activities may also be tagged as optional or essential, and if optional their costs could be suppressed to see how total budget is affected.

In various embodiments, a visual process manager tool is implemented. It may include the following features: 1) Each Process (e.g., draft application, office action report, response, etc.) has a timeline (or calendar). Timeline is visual of process due dates and milestones; 2) each process has its own Process Options or Decisions; 3) each process has a messaging area that attorneys/paralegals may post messages regarding the process. These messages may then be sent to client via one or more or all of media: e-mail, text, written letter, telephone call (recorded); 4) each process has messaging area that may store and retain key client messages or instructions, either in the form of a recorded telephone call or message, a saved e-mail, a saved text message, an image of a document; 5) process may require client verification of key processes by either: automated telephone call with dtmf of voice response; automated e-mail with reply or click through to page with verification options.

In various embodiments, for a process (e.g., foreign filing in and maintenance fee decisions), a process verification engine may obtain verification of key decisions from client and if no such verification is obtained, an alarm may be triggered. The process may include the following: 1) foreign filing paralegal obtains client instructions; 2) paralegal tells client they will be required to provide us verification. Verification may be obtained from a known/approved phone number or using an approved e-mail or fax or using some other authentication (at customer option perhaps); 3) client then, for example, gets telephone call to verify instructions that are recorded in the system (for example from a menu of options—“no filing”, file in PCT, file in (pick countries), or they receive an email and have to reply “confirmed” or click through. In an embodiment, the verification is offered as an option to one or more templates for a process. In another embodiment, this may be a separate key process verification engine that ran verification separate from a main docketing engine. In various embodiments, verification may require a bulk process.

In various embodiments, a tool of a docketing system may offer possible procedures available for an attorney or client for each activity. The possible procedures may be based on milestones and advantages/disadvantages for each procedure and cost.

In various embodiments, a docketing management tool may keep standardized instructions, or instructions customized for particular clients. These instructions may them be readily associated with processes or reporting procedures so they are consistently delivered to clients. For example, if a client views a dashboard or gets a report out email.

In an embodiment, a tool keeps track of and maintains the purpose for which a patent is being pursued. This information may be provided to the attorney or other appropriate personnel during key decisions making times during the patent's lifetime. This information may be used by the appropriate personnel to determine whether to open prosecution, file for appeal, pay issue fee, pay maintenance fee, enforce patent, etc. Often times, over the course of a patent's lifetime, personnel on both the client and attorney side change and the reason for filing that patent is lost. This is important, because as time goes on, this reason may no longer be relevant and proceeding with prosecution or continuing to pay maintenance fees may no longer be necessary. Therefore, this tool helps to enable clients to pursue only those inventions for which the reasons for filing the patents are still necessary and relevant. Purpose oriented prosecution will thus save time and money involved in filing, pursuing, and maintaining patents that are ostensibly useless for the client.

In an embodiment, a docketing management system includes an interface with a claim chart with claim history of each claim allowing a user to drill down into claim versions, office actions, or responses etc. This data may be retrieved from one or more databases of a docketing management system or other external databases.

In an embodiment, data may be tagged in a docket management system with a universal code to be used for external data verification such as an external Docketing system. The universal codes may be distributed to all system providers and users. The universal codes may also be used to port data.

In various embodiments, a web services (e.g., an API provided by the docketing management system that may be incorporated into third party applications) is used to interact with a docketing management system without the use of a visual user interface. The API may include the following abilities: Ability to add, update and mark references in FIP without the UI; Ability to upload in bulk the reference images that have been obtained from other sources; and Ability to download reference images for the purpose of integrating with other applications or attaching to Outlook emails. These may be implemented as a means of bulk downloading and renaming references in the proper format for sending to the USPTO with a 1449 document.

In an embodiment, the API allows for the ability to download or upload a document(s) from an activity in the docketing management system. This may be used for bulk downloading an entire client's documents when transferring the client out as a means of supplying electronic documents to the new representative of the client.

In an embodiment, an e-mail client within a docketing management system has the ability to obtain the “replyID” for the subject line of an email message that when added to a message created outside of the docketing management system and sent to a docketing management system email address will place the message in the appropriate activity. This may incorporate the document download web service to automatically attach an associated document.

In an embodiment, the API allows for entering billing entries into the docketing management system. This may allow for quick bulk entries of billing entries.

In an embodiment, the docketing management system includes a feature of queuing generated “notifier” emails for docket items that get sent to internal matter personnel to be sent the following day rather than immediately. This may allow documents to be added prior to the notifications so that the activity is complete with all the information.

In an embodiment, the docketing management system includes translation tools to send data to other software programs. For example, tasks in an external productivity suite (e.g., MICROSOFT OUTLOOK™) may be created from docketed due dates in the docketing management system. The docketing management system may send e-mail summaries the tasks that have been created, tasks that are due, and tasks that are upcoming (e.g., due in two weeks). In various embodiments, e-mail messages may also be created that include documents from the docketing management system and with the “replyID” web service automatically re-files itself into docketing management system upon receiving a reply message.

In an embodiment, the docketing management system includes the ability to forward e-mails to other e-mail accounts. A tool may also include the ability to selectively determine which emails to forward (e.g., such that notifier emails and internal report out emails may not be forwarded).

In various example embodiments, a docket management tool may keep a backup docket for foreign filing. In one example embodiment, the docketing management tool may allow a customer to add an attorney in a company to a customer number. In some example embodiments, the tool may allow the company to be added to the customer number in other ways. The docketing management tool may determine docketing for select or all events. In some example embodiments, the docket may be displayed online. Docket items may be crossed off/verified (e.g., by a user of the system) when something is filed. In some example embodiments, for critical dates (e.g., a foreign filing deadline), the system and/or method may perform one or more of the following:

1) obtains validation of a non-filing decision through an interactive user interface;

2) validates a foreign filing by receiving a copy of a foreign filing confirmation (like PCT filing) and by comparing filed application with priority application;

3) validates a foreign filing case (e.g., at the time filing is requested) by using a priority application;

4) validates PCT cases (e.g., online);

5) allows staff to follow system guided escalating alert system to investigate unverified filing decisions.

In various embodiments, a docketing management tool may be used for docket checks or verification based on state- or rule-based predictive docketing. Following are features that may be included in the tool:

1. Predict or determine likely or possible docket activities based on state of case;

2. Check any incoming PTO action to verify it is within expectations based on rules/state;

3. Check any docket entry to make sure it is within expectations based on rules/state;

4. Develop rule base by training algorithm on existing cases.

In various embodiments, a tool may be used to allow attorneys quicker access to file documentation in a shadow file system (e.g., that would not be used to store information permanently, except some notes that may be copied back into the system once prosecution is completed, or along the way automatically). In some example embodiments, this tool may include the following features:

1. Folder file system that may synchronize folders to any computer;

2. One main file folder for each matter in the system (e.g., created automatically when the matter is opened);

3. Creating (e.g. automatically) a Notes sub-folder, a USPTO-cited prior art sub-folder under the main folder, and a Save Notes sub-folder;

4. Creating (e.g., automatically) a sub-folder for each Activity in the system, and copying (e.g., automatically) all documents from the Activity into sub-folder;

5. Copying (e.g., automatically) all USPTO-cited prior art in a USPTO cited art folder;

6. Users may access these folders from the network and synchronize the folders to their desktop computer or to a laptop or any other computer device that supports the synchronization (e.g., the iPad);

7. Synchronize the Save Notes sub-folder back to the system (e.g., copy notes to a designated Activity, such as the permanent Admin Activity);

8. Once file is abandoned or issued, the main file folder is zapped unless it is first dragged and dropped into a child/related case file. All synchronized folders may also be zapped at the same time.

In some example embodiments, the tool may synchronize files (e.g., automatically) to any PC used by an attorney. In one example embodiment, only those files actually being worked on by the attorney are synchronized. In one example embodiment, the user may select a file to synchronize from a web-page, or from a link sent with an e-mail when a communication is received.

In some example embodiments, a docketing management tool may include one or more of the following features:

1. Have a verification mark that is applied to a docket date description;

2. Dynamic docket object tied to USPTO data type.

In various example embodiments, a docketing management tool may include one or more of the following features:

1. Docket URL—points to USPTO-based docket date—put in docket activity;

2. Active component in docket activity like FIP where it dynamically updates with date from USPTO based;

3. Dynamic link to independently calculated date.

Claim Mapping

In various embodiments, a tool may run analytics on scope concepts or claim keyword Google Search using: a. Scope Concepts are fed into Google, or otherwise used to search Internet, to generate a list of search results; b. Differences in Search Results from one day to the next, or one week to the next, is displayed as “new results”; c. Search is done either on all Internet or is executed only to look for appearance of hits on specific competitors; d. new search results are shown each day or periodically; e. Same thing may be done as above, but instead of using scope concept, the tool takes the keywords from the claim and use those keywords (keywords from claims may either be just all non-routine words or may be determined by looking to see which keywords are unique compared to cited prior art); f. generate search results from web for informational purposes; and g. may use linguistic analysis to find matches.

In various embodiments, a tool may organize concepts within Panoramic Claim Charts. The process may include: a) meta-label sort to organize concepts under meta-labels; b) meta-labels are like Scope Concept groups; c) have Scope Concept groups that are added by mapper, and may organize map output by the groups; d) ability to direct/specify the order Scope Concepts are displayed, and be able to store for later reuse as well as be able to hide concepts too.

In various embodiments, concepts from independent claims may be applied to dependent claims by: a) rolling down of mapping from independent claims to dependent claims; b) Optional reporting on that—so show in panoramic map, make roll down optional, (i.e., treat independent claim limitations as if they were part of dependent claims, or not, optionally); c) relationship may be calculated on the fly.

In various embodiments a tool is used to determine a claim similarity and uses a claim similarity index to identify claims to map scope concepts to. The similarity of paragraph of claims or total claim may be measured by: a) keyword similarity—roots of words are compared after throwing out unimportant words; b) linguistic analysis—how similar based on other approaches. In one implementation, a mapping system may suggest to users mapping claims which claims are most similar to one another, or what parts of claims are most similar to one another. In another implementation, claims are just flagged as similar for later use. In an embodiment, claims are determined to be similar based on keyword similarity

In various embodiments a tool is used when mapping claims allowing a user to highlight the claim terms associated with a scope concept across a number of claims, storing those associations, and then when subsequently displaying those claims. For example, showing which claim terms have already been mapped (e.g., by highlighting those terms, perhaps in different colors for better visualization). This may be helpful in those cases where you move to another patent and have already mapped portions of claims. This would make it easier to see what you've mapped. In an embodiment the system automatically identifies common claim terms or elements and displays this so a user could map them more quickly. The user may define common claim terms or set a filter them based on unique words or phrases of a certain number of words.

In various embodiments a tool is used to aid in mapping claims to a product. For example, instead of using claim map, the tool show claims parsed by paragraph. Next to each paragraph, a user may indicate if the product includes the technology described in the claim.

In an embodiment, a tool is implemented for use in mapping and product analysis. The tool may: 1) grab Field of Invention and present with claim map; 2) grab claim segment or segments, maybe one or two per claim, that look to define point of novelty or at least help position scope of claim—optionally link to specification segment; 3) indicate how much of claim percentage wise is in limitations; 4) display mapped claim elements in chart that user may designate “relevant” or “not relevant.”; 5) optionally calculate relevance to a product or technology; 6) optionally keyword map the chosen claim segment and show keyword chart; 7) optionally allow user to designate relevance of keywords and optionally automatically calculate relevance to product; 8) optionally add more keyword as synonyms; and 9) use keywords, synonyms, field of invention and/or mapped segments, or other patent-related information to find related products on web sites or to find similar patents that are later issued.

In an embodiment, the technical field of a matter is issued as a claim mapping concept. The technical field may then be used as fuzzy scoring technique to score the relevancy to a technology or product.

In an embodiment, a tool is used to use keywords of a claim to rate its relevance to a product. For example, claim keywords or phrases are isolated from claims and associated with claims. Users may rate the applicability of the isolated keywords or phrases to a target technology/product. The ratings may be used to determine score of relevance of claim to technology/product. The result may be an indication of relevance, where relevance is determined by exclusion like in claim mapping.

Portfolio Analytics

In various embodiments, a tool for portfolio analytics may be used that has the following features: a. Keep cases organized by: i. List of all Individual Matters; ii. For each Matter, a list of family matters; iii. For each Matter, a list of prior art; iv. Matters may be organized into Portfolios; 1. For each portfolio, there is a “roll-up”; a. A group of matters; b. A group of prior art references (from all matters); c. A superset group of family members (from all matters) (note, all family matters may be in portfolio so in that case it would be redundant); b. Generate analytics for individual matters; i. Matter itself; ii. For family group; iii. For prior art group for the matter; c. Generate analytics for Portfolio; i. For aggregate of Matters in portfolio; ii. For aggregate of Prior Art in portfolio; iii. For aggregate of Family members for portfolio; d. Add list of competitors; i. Generate comparisons between patents owned by competitors and Matters in portfolio; 1. By technology—class/subclass/other; 2. By other groupings; e. Add list of technologies—e.g. by class/subclass or by other criteria; i. Generate comparisons based on technologies.

In an embodiment, a tool may rate importance of a US continuation by automatically determining the amount of overlap with a prior case. For example, 1) are claims longer or shorter? 2) what is the keyword overlap or uniqueness between cases? More or less keywords? 3) What are the common and unique claim limitations?

In an embodiment, a tool is used to compare issued patent claims with published claims to generate “novelty” material. Here the tool may look for words or word roots or phrases found in issued claims but not in published patent. These changes may represent the most novel portions of the claims. This may be used for various purposes. For mapping, it may be used to help identify a novelty scope concept. For just understanding patent, or potential FWE, it may show what was added to claims. One output may be patent claims showing which words were not in application claims as published. A map may be generated with automated patent mapping to identify interesting material to map. In an embodiment, the tool may use keyword differences between the issued claims and keywords not found in the prior art to help define uniqueness. The tool may highlight new (those not found frequently or at all in the prior art) terms in the issued claims.

In an embodiment, a tool is used to look at abandonment rate for class/subclass or prior art family. Also, the rate of abandonment for the prior art for a case, and particular art, may be determined. In various embodiments, the tool may look at 102/x reference rate and display the rate to a user. Abandonment suggestions may be based on the same analysis.

In various embodiments, a tool is used to look at the internal versus external ratings of a patent. For example, the tool may create a rating for a patent that is based on relevance to the company's own key technologies/patents and a rating for external companies—relevance to the other company's key technologies/patents.

In an embodiment, for the internal rating for Subject Company:

Identify automatically or manually the best patents a company has; a. For example by company picking them; b. Or by looking at how many times patent is cited; 2. Rate any given patent of the Subject Company by its relevance to the best patents a company has, 3. Other parameters.

In an embodiment, for the external rating for the Subject Company: 1. For any given Competitor company, figure out the one or more best patents that the company has; and 2. Rate the relevance of any give patent of the Subject Company to the Competitor Company. In other words, for external ratings, the relevance of any given patent of the Subject Company (one for example you may need to pay an annuity on) to each Competitor is rated Competitors may be used picked, or determined by which companies have patents in same class/subclass or cited against Subject Patent.

In various embodiments, a tool is implemented to determine what classes/technologies a company has the best position in. This may be based on percent of a class/subclass and total number of citations. The tool may determine open areas for a company based on existing filings. For example, it may show the areas with the most promise for patenting based on a number of patents and timeline for the class (e.g., how close to the beginning of filings for a particular area).

In an embodiment, a tool is used to analyze the overlap between two or more portfolios. For example, a user interface may allow a user to enter two or more patent owners. Then, the user may pick one of owners and select at least one class/subclass for the owner. A graphic may be generated which shows the overlap between the two or more portfolios for the selected classes/subclasses. The overlap may be determined based on one or more criteria: 1) Specify a time window for published or issued apps/patents; 2) Overlap based on direct cross-citation to one another by owner; 3) Overlap based on cross-citation relationships of intermediary companies; 4) Dominance analysis—how many forward cites to each company have to one another; 5) Weighted cross-citation overlap—weight the cross-cites by importance of patents (based on forward citations or other criteria) or 6) based on number of patents in the same sub-classes. Various types of graphics of the overlapping data may be used such as bar charts comparing number of patents each have or a pie chart with portions overlapping.

In various embodiments, a tool is used to determine a value for one or more patents. A Patent Value Units (PVU) may be used as the basis for the valuation. A base value of ‘1’ PVU may be used when an issued patent has no forward cites. Then each forward cite multiplies the value. Some forward cites may multiply the value more than others. Using this valuation methodology, a value of a portfolio of patents may be determined. Valuations may also look at the correlation between industry sales and classes of patents and dollar volume of products to attempt to see how much each patent represents in terms of revenue in industry. For example, consider that there are 25,000 memory patents, and $100 B in memory sales. Each patent then may represent $4000 in revenue. In an embodiment, the value of patents may be based on estimated R&D spent. These values may be compared relative to other portfolios. Relative valuation may take into account many factors including: 1) forward citation of the portfolio; 2) which owner had more dominance; 3) age of portfolio; and 4) value of technology correlated to patents

In various example embodiments, a tool for portfolio analytics may be used that may have the following features:

a. For a patent,
i. Shows graph of priority dates of prior art;
ii. Shows graph of priority dates of class;
iii. Calculates growth or shrinkage of patents in class;
iv. Shows where patent falls in priority dates.

In some example embodiments, a tool may be used to count claim limitations. This tool may, for each claim, count limitations or words, or rate each against class as a whole or prior art.

In some example embodiments, a tool may allow a user to enter keyword combinations and perform proximity searches. The tool may show a histogram of patents meeting criteria by year.

In various example embodiments, a tool may pull out representative passages from a patent that correspond to the main point of novelty and find the best hits in silo (e.g., a repository of data).

In some embodiments, a tool may be used to generate a web site index that correlates patents owners' patents to patent owners' web site pages. The tool may use automated analytics to perform the following:

1) Identify a web site for each patent owner in a patent owner list;

2) For each web site found, correlate each page of the web site to patents for the owner based on one or more of the following:
1) keywords from title;
2) technical field;
3) abstract;
4) claims;
5) ranked combined list (e.g., which patents hit all categories);
   Each match list may be different for each set of keywords. In some example embodiments, the tool may cache each page and save old pages as new ones replace them. In certain example embodiments, the tool may start with the top 1000 companies and proceed from there as more is learned.

In various example embodiments, a tool may be used to rate references based on their similarity to each other. The tool may also provide the similarity rating for all the references in a list of references. The level of similarity may be determined by examining one or more of the following measures:

1) Overlap of all keywords in patents;

2) Overlap of keywords from claim to other patent;

3) Overlap of keywords found in technical field to other patent;

4) Overlap of keywords from abstract to other patent.

In some example embodiments, a tool may be implemented to display:

1) next to each claim of a patent, a count of how many keywords associated with the claim are found in one paragraph, or within two paragraphs, or within one patent, of references associated with the claims;

2) under the “references” category, the list of references in a portfolio, and, under the “claim” category, a claim for one of the patent matters in the portfolio;

3) a novelty rating for one or more claim(s) determined based on keyword metrics.

In various example embodiments, a tool may be used to implement a multi-factor weighted scoring system using a keyword search on the title, abstract, and other portions of the document to determine relevance. In some example embodiments, the tool may be used to analyze already-cited documents to search the patent documents cited on their first pages as a search space in order to cross-reference with uncited documents. If, for example, a currently uncited document appeared on the face of an already-cited document, then the tool may include it (e.g., automatically) in an IDS. Other examples of items that may be cross-referenced with the uncited reference under consideration may include: inventors, correspondence address, assignee, US or international classification, and a law firm name determined from the front page of a published patent or application.

Annuity Management

In various embodiments, a tool for annuity payment architecture has: a. Have master US patent database, and foreign patent database; b. Allow subscribers to identify their patents in this pre-populated database; and c. Set up payment option for them.

In various embodiments, a tool is used for annuity follow me tracking. For example, the tool may track owners of patents so that when it is time to pay annuity, they may be found. Features may include: a) track patent requiring annuity; b) add contact for patent—name, physical address, emails, text message address, mobile, land line; c) add second or third backup contacts-names, physical address, emails, phones, employers, social security number if possible; d) contact is pinged periodically, automatically; e) if no reply, ping goes to backups to find owner; f) lack of contact info for owner is identified early; g) This functionality may be tied to either: 1) a single patent; 2) a group of patents; h) UI—user sees list of patent(s). User may choose “follow me” service for reminders on these patents; i) reminders may come multiple ways—as noted above; j) add reminders to LinkedIn or to Facebook—social network tie-in. these are places that someone would likely stay connected to; k) connect to LinkedIn or Facebook, or other SN, and monitor if the person is present, and if the person disappears from there, flag them as “missing” to invoke follow up tracking; 1) have application in LinkedIn or Facebook that keeps track of patent maintenance fee due dates, and notifies user when due; m) have iPhone/smart phone app that keeps track of dates, they could be embedded in App not only downloaded, and generates alerts for payment—while fee may change, typically date due will not; n) create a “remind me” hierarchy—start with automated e-mail/call/text to first person on list. If they don't reply, go to the second person, and so on, till you exhaust list, trying to reach someone.

In an embodiment, a tool for Maintenance Fee Portfolio Optimizer may look at variables that may be controlled for maintenance fee payment (e.g., a service provider, exchange rate, payment date) across a number of countries and makes recommendations for savings and the estimated amount of savings.

In various embodiments, a User Interface for a Maintenance Fee Analyzer Site may be implemented. The site may: A) provides access to the Maintenance Fee database; B) User Interface Features may include: i. Look up any patent or application in database; ii. show user the annuity fee for that case; a. how user currency conversion based on two or more dates that currency would be purchased;—within a range, say default 6 months prior to payment date, show highest and lowest currency conversion quotes; b. allow user to specify “pricing date” used to price the currency conversion; iii. show user if agent fee is required; iv. show user typical annuity provider fees; v. allow user to price out a cost to pay fee; vi. Allow user to configure annuity provider charge profile—a) amount of provider fee; b) amount of currency mark-up; c) use reasonable agent fee (or none); d) estimate cost of payment, based on today's currency conversion rates; C) Allow user to “find family” for any given case they are looking at and show the family; a) provide maintenance fee estimates for those cases; b) estimate total cost of family. The user interface may also pull terminal disclaimer data for a patent and display it to the user.

In an embodiment, a tool for Credit-based Annuity Payment Processing is implemented. The features may include: a) In annuity payment system, credit score may be deemed important to getting paid; b) score the credit risk for all annuity payments made in the patent management system; c) credit scores based on owners would be pulled into system; d) credit risk may be judged by prior history of paying PTO fees or WIPO cases—abandonment of these cases would indicate poor credit; e) Using score, the tool may adjust pricing and/or flag high risk payments; f) the tool may help implement the purchase of credit-insurance for each risky payment, from an outside funding source; g) Secondarily, the tool may offer credit option for some customers based on risk, but finance the credit option with an outside funding source; h) Credit risky owners may be flagged and correlate to patent holdings, so patent purchasing agents and trolls could see who was in need of financing.

In various embodiments, a tool is used for an international patent registry architecture. The architecture may be implemented in a variety of ways such as: 1. For each country, there is a maintenance fee registry or database that is synchronized with, mirrored or is actual integrated with a country's equivalent of a PAIR/maintenance fee system. a. In one embodiment, this registry or database simply reflects the actual due dates kept on the PAIR system—i.e. the registry database does not calculate due dates, but simply reflects the due dates presented by the PAIR system. b. Similarly, the registry database also simply reflects the amounts due showing on the PAIR system, as opposed to keeping a separate database of them. 2. This registry could be one computer system/database that spans all the patent offices it serves, or be split. 3. There may be no docket maintained separate from the PAIR system—so the tool helps to eliminate the possibility of errors of keeping docket dates. (note, most if not all docket systems keep due dates for annuity payments based on a set of docket rules, not based on what is in PAIR itself.) 4. Separately from the Registry database, there may be a database that keeps track of patents/apps owned by a particular company (e.g., an external database that may also keep track of due dates for annuities, separately from the PAIR system). 5. This external system may talk to the Registry database, and register with the Registry database to have the Registry make a payment on a particular patent a. the tool may allow various heterogeneous (e.g., systems from different vendors like) docket or matter management systems to register with it to pay annuities. This may be different than current architecture in that some of the patent maintenance payment providers pay only fees for customers they handle, and only pay through their own database systems. In the offered architecture, there may be a payment engine/registry that may be shared by all the vendors or patent owners to make sure payments are made on patents they tag in the database, and also various extra features may be affected through this architecture. As these registries grow to represent more and more patent offices, the principle function of annuity payment providers today may shift to simply tracking what patents a particular company owns, with the dates/costs/payment pipelines being provided by the registry.

In an embodiment, a direct pay conduit tool is used for the registry:

a. The Registry may provide a verifiable direct payment conduit.

b. I.e., a corporation could provide an account/letter of credit/other payment facility that may be drawn down by patent office authority, and such that only patents registered for payment through the Registry may be paid using the payment facility.

6. Payment authorization options:

a. In one architecture, Registry provides the payment information to the docketing/Matter management vendor (such as CPI/CPA), and that vendor get approval from the Owner to pay the fees

b. Docketing/Matter management Vendor authorizes Registry to draw down on Owner's payment facility.

c. Registry verifies with Owner that it is ok to drawn down on the total $$, with an itemized report of what they plan on paying if desired. Owner may verify electronically, or Registry may get paper or voice approval

d. Authorization keys are provided to run system.

7. Themes of the architecture may be:

a. Distributed—

i. For any given owner, the tracking of ownership of patents done in one system.

1. routine docketing done in this system, but

2. maintenance fee docket dates are extracted from a different system.

ii. the amounts due and dates due for annuities/maintenance fees kept in another system—the patent registry.

b. Payment pipeline is different—

i. Instead of patent owners paying the docket/matter management system vendor for payment of annuities, annuities are paid through the Patent Registry.

ii. Payments are made to the registry entity, electronically orchestrated or tracked by registry.

iii. System vendor does not touch money paid to PTO, that money is routed through registry system or entity

iv. System vendor gets paid for tracking ownership of patents and registering for payment, but not for paying fee itself.

v. Payment could be made by patent owner directly to PTO through conduit provided by Registry

vi. Registry may provide an electronic exchange to pay annuities in any currency, either directly into PTO system or through a banking/financial system

In an embodiment, a tool is implemented as a Patent Office Payment Registry. Some annuity payment services may rely on keeping a proprietary database of patent information, where the annuity payment service has a client, and the client tells the annuity payment service which patent matters (patents or applications outside US) that the client wants the annuity payment service to handle for the purpose of annuity payment. As such, various different Annuity payment services may keep track of various different clients to handle payments for those clients and their matters. The tool changes this paradigm. In the new paradigm, the tool may provide a single payment registry, where there is just one representation of each matter in any particular patent office like the USPTO and all the issued patents.) Customers of the registries are the patent owners or their agents.

In an embodiment, the tool functions as follows: 1. Customers of the patent registry become registered users with the registry site. 2. Registered users may tag any patent as a patent they want paid. Tagging may take place in a variety of ways: a. Pick a patent one at a time; b. Upload a list of patents; c. Search for patents that the owner is record owner of; 3. Registered users may specify payment options: a. Always pay; b. Pay only if instructed to pay; c. Pay under certain other circumstances. 4. Registered users may specify different funding mechanisms: a. PayPal; b. Credit card; c. Bank account; d. Back up payment methods; e. Apply for credit. 5. Registered users may request “forward contract” pricing for payment of fees in other currencies. 6. Registered users may get quotes for currency conversion rates on a real time basis. 7. System provides various features: a. Cost projections; b. Analytics; c. Claim maps; d. Title verification. 8. Database is secure, and all tagging may be encrypted. 9. Users may be notified if: a. Someone else tags the same patent; b. They seek to remove a tag before another entity adds one; c. A payment was not made; d. Various other situations. 10. Users may pay for “track me” feature that collects back up contact information and follows the registered user to make sure they are available to authorize payments. 11. Users may pre-pay fees, held in escrow, to make sure payments are made. 12. Patent families may be registered at one time, both U.S. or international families. In an embodiment, pricing for annuity payment is dynamically quoted during payment authorization process. And price locked with order to pay annuity. Card is charged later on due date or date before that.

In various embodiments, a tool is used to help eliminate the mark up for currency conversion. For example a payment infrastructure may be used that may support a more economical way to price/convert currency using forward contracts. Generally, the price of a forward contract is the cost of the currency on the day the contract is purchased, plus the cost of interest to hold the currency till it is delivered. This could be as little as 1% in interest cost, as compared to 6% to 20% markup. The tool may work as follows: 1) track annuity payments due for an owner like a large European company with payments in US. 2) the tool may have a docket of due date for each patent. 3) at a specified date in advance of the due date, for example 3 or 6 months, the tool prices out how much it would cost to buy a forward contract of currency equal to the total amount of fees due on all patents being tracked that are coming due on that particular date, or due within a date range, like all fees due in a calendar month. In an alternate embodiment this may be done for one patent at a time. The cost of the forward contract is then apportioned to all the patents pro-rata based on the actual annuity fee, for the purpose of showing how much it will cost to pay each maintenance fee. The tool may provide the pricing infrastructure to support this transaction.

In an embodiment: 1) a European company (EC) may sign up to use the tool and; 2) the tool synchronizes/receives tracking data from the EC's annuity payment service (e.g., Computer Patent Annuities); 3) on a specified day in advance of when a batch of payments are due in the USPTO, the tool prices a forward contract for that batch of patents using forward contract rates we get from a participating bank; 4) the price of the currency is provided to annuity payment company (APC), which in turn uses it to send upcoming payment reports to its EC with a list of annuities due and an amount for each; 5) EC instructs APC to make payments in US; 6) APC notifies system/bank on how much to send to USPTO to cover cost of payment for list of annuities to be paid; 7) bank wire transfers money to a USPTO account—this could be automated. In this model, EC pays bank directly for cost of annuities. Or, APC could pay bank and APC collect from annuity provider.

In an embodiment, a tool is used that uses claim tracking data for annuity management. By using detailed rejection data or composite claims the tool may gauge how close a patent is to prior art. For example the tool might see exactly what was added to claims to gain allowance.

In an embodiment, an annuity site reports on maintenance fees not paid and sets alerts for nonpayment. Alerts may be carry over when ownership changes.

In an embodiment, a tool is used for prosecution history to help make annuity decision or as rating metric. To determine value of claims, the tool may look at number of novelty or other rejections in US prosecution or in PCT or EPO search reports.

In an embodiment, a tool is used so that any payment agent could quote a forward contract amount for any patent, and owner may commit to using the forward payment in advance of forward date and the tool will track it all. Each user could either have a default forward date or pick a specific date dynamically on the day of before it. The interface may be integrated into the PTO payment system.

In various embodiments, a maintenance fee payments tool may be used. The tool may be implemented as a website and the site may show maintenance fees due for US and foreign and due dates. Users may follow certain matters and receive free cost projections. Users may get free quotes for payment from vendors. The site may use US and INPADOC (“International Patent Documentation Center”) and other data. A User may get quote for owner-based group/portfolio. Users may view payment status and look up on app. The site may also feature “follow me” feature and other options to assure notice of fee due or payment of fee. Site may feature fee schedules for annuities for all countries and docket could show recovery options for lapsed patents due to nonpayment. The site may give fees for each case, due date, term remaining, sales of similar technology products, enforcement information. It may also shows family data, cost projections, measures of value. It may also mark patents that are in litigation and mark patents in the orange book.

In an embodiment, a tool is implanted as a web site hosted by a payment agent. The payment web site may be linked/integrated with USPTO payment interfaces and feature:

1. User identifies patents they want maintenance fees paid for

a. these patents would have payments due at various times

2. User provides a credit card to use to pay the maintenance fees

3. Payment web site pre-authorizes card for upcoming weeks/months payments

a. any issues, it notifies owner of card there is an issue

4. Payment web site uses card to go online at USPTO and execute payment for Patent Owner

5. Later, payment web site downloads AMEX/Visa transactions from web site (and other transaction data from AMEX/Visa) and reconciles payments automatically (or semi-automatically)

Payment Interface:

1. May be integrated with Annuity docket date system, and take information from annuity.

In an embodiment, a tool is used for managing international annuity payments. In an embodiment, first, USPTO opens its window for payment of annuities six months before annuity is due. At the beginning of the six month period the USPTO or other payment agent prices out the cost a dollar denominated maintenance fee in one or more other currencies. The other currencies may be priced as forward contracts. The amount of contracts to buy is based on statistical averages for payment of annuities, either as a whole or based on specific companies. In an embodiment, to qualify to pay in a foreign currency a company must enroll/designate at the USPTO and is allowed to pay on any patents either it specifically identifies and/or it owns at the time the payment is made. The company may not be allowed to pay in dollars or they would have to pay a penalty fee if they did after agreeing to pay in another currency. In an embodiment, the above, except window for payment in foreign currency at quoted rate is only 60 to 90 days. In an embodiment, the above, but money to pay the maintenance fee is put in deposit account channeled through bank that converts and deposits in deposit account.

In an embodiment, a method of using the tool for international annuity payments works as follows: 1) User designates which patents they have on annuity docket for upcoming payment; 2) software calculates how much funding in foreign currency at moment will be required to pay fees and quotes fee in currency for each patent; 3) company deposits estimated payment in deposit account through bank agent; and 4) company now may pay any of the quoted patents by hitting deposit account—fee is already funded by pre-deposit

In an embodiment, a method of using the tool for international annuity payments works as follows: 1) estimates of fees owed is done upon opening of window or at any time in payment window; 2) patent owner pays bank for currency—bank makes funds available to any case with a specified deposit account supported by bank; 3) cost per case in Yen (or other currency) is giving to annuity payment company to price payments, or simply give them the exchange rate used; and 4) bank either puts money in deposit account or essentially PTO bills bank for fees once the charge hits, by wire transfer request.

In an embodiment, a method of using the tool for international annuity payments works as follows: 1) Annuity provider exposes list of cases to be paid for company X on any given day, 2) bank software quotes an exchange rate; 3) annuity software uses exchange rate to calculate amount due for fee; 4) company X buys currency from bank for fees at quoted rate; and 5) bank provides deposit account funding for all patents in batch.

Market Analysis

In an embodiment, a tool is used for white space indicators for Analytics. This may indicate when an invention/patent is in a crowded space or is in a “white space”. The concept is to give the User an idea of which areas they are working in are most fertile. Also, it may help create a strategy for filing. Potential ways to indicate include: 1. For the class/subclass of the invention, how many patents are in the class/subclass (fewer is less crowded); 2. For the class/subclass, how old is the earliest patent in the class/subclass (newer is less crowded); 3. How old is the applied prior art cited against the patent? Or How old is unapplied art cited?; 4. What is the distribution of age of patents cited as prior art in the class/subclass (newer is less crowded); 5. Using keywords, determine how many patents each competitor has, or how many patents there are, in key technology areas; 6. Specific design: a) User creates a “Technology” to be added to a Technology list; b) For a Technology, user may do one or more of the following: i. Specify Representative Patents or Applications; ii. Specify Representative Keywords; iii. Specify Representative Classes/Subclasses; c) System uses one or more of these to calculate a parameter or graph showing if the Technology area is crowded or has white space; 7. 2nd Specific design: a) For any given patent or patent application, system uses keywords from the patent/application/claims and the classes/subclasses and other parameters like prior art, to determine if patent is crowded or open Technology area.

In an embodiment, important business information will be pushed to the client/and or working attorney at key decision making times with the goal of aligning business and IP strategies. A system may include an interface for the client to input information regarding business strategy on a continual basis and another interface to present the compiled information to the client at a later time, or to the working attorney. That information may be sent to the client or attorney throughout the lifetime of a patent (i.e. invention harvest and evaluation through post prosecution). Specifically, the information may consist of a revenue contribution ranking for the client's products as well as the competitors' products for each geographic region for which the invention is to be made, sold or transported. Information for each client may be organized into and associated with four separate categories: 1. Technology Area: 2. Competitors; 3. Geographic Regions; and 4. Revenue.

In various embodiments, each matter may be categorized into a distinct technology category. Technology categories may be general, specific to each client, or depending on the client, may be categorized by the specific product. For example, a bicycle company may have category for frames, brakes, wheels, gears and steering. Some inventions may fall into multiple categories. In the example of a bicycle company, an invention that changed gears each time the brakes were applied would fall into both the gears and brakes categories.

In various embodiments, each client/invention may also have a number of competitors associated with them. Competitors' information may include information for direct competitors, indirect competitors and benchmark competitors. The competitor's category may simply include all of the client's competitors, or may be more narrow in that it only includes competitors for the specific technology category, or may be even more narrow and include only competitors for the specific product.

Geographic information may include market, manufacture and transport information for all the regions that the invention is to be sold, made and transported.

Revenue information may be a scaled representation of the invention's contribution to the overall revenue of the client. This information may simply be represented on a scale from 1 to 10, or by some other more complicated arithmetic scale. Revenue contribution ranking is not a percentage of revenue generated by a specific production, but rather a ranking of importance of the contribution to the clients' (and competitors') overall revenue.

Each category of information may be related and contained in a multidimensional information matrix. In other words, each invention may be categorized into at least one technology category. Each of these technology categories may have a set of associated direct, indirect and benchmark competitors. Also, each of these competitors, as well as the client's invention, may have an associated revenue contribution ranking. Finally, every geographic region for which the invention is to be sold, manufactured and transported may have the above mentioned information.

All information may be updated by the client on a continual basis so that the attorney handling the matter may make informed decisions regarding the prosecution/maintenance of the patent that are in line with the client's business strategies.

For instance, the information may be presented to the attorney prosecuting a matter for which a final office action has been received. At this point the attorney may use the revenue information to decide whether an appeal should be filed or whether the application should be abandoned based on the overall importance of that invention to the client's revenue for that particular geographic location.

In another example, the revenue information may be presented during post issuance at a time near the due date of a maintenance fee. The information may then be used to decide whether a maintenance fee should be paid during post issuance.

In an embodiment, tool (e.g., extension of a browser) finds all patents that are relevant to a web page during browsing with the ability to filter the patents. This tool may be loaded in a tool bar and an algorithm would match patents to the text on the web site (e.g., using a similarity algorithm of claims to words on the web page). The toolbar may allow a user to put in the name of the company the user is looking for, find the company in a patent database, and then display patents that the company has or filter down to patents related to the page.

User Interfaces

In various embodiments, for the tools discussed herein a user interface may be used to determine which services a user may elect. For example: 1) User loads list of US patent/app cases into Portfolio manager, 2) each patent/app may have the following button options: a) sign up/select option to find foreign equivalents or US family, and load if desired. A-1) sign up for title guard—a tool monitors title changes, b) sign up for maintenance fee payment alerts—a tool monitors for either payments due and/or send an alert if payment not made, c) a tool offers to make payment if one is due—this is done with multiple payment options; d) sign up for basic citation alerts—any forward cite, e) sign up for advanced citation alert—a tool looks at forward citations of related patents like citation of an applied or unapplied prior art reference, or a forward cite of a forward cited patent, or a forward cite of a sibling patent, e-1) sign up for PTO Pair alerts, e-2) sign up to look for cites to the patent in pending apps, f) sign up for advanced metrics—a package of advanced analytics metrics, g) sign up for Internet watch for patent-set parameters to generate web hits that are related to patent, h) sign up for troll/patent trading activity alert—a tool detects how many patents in the same class/subclass or in other related group have changed owners in a time period.

Strategic Monitoring

In various embodiments, a tool is used to track ownership changes. This tool may be implemented as is a web site that shows daily list of changes in patent owners; assignments to newly formed companies; assignments to LLC's; assignments to corporations; assignments between existing companies; assignment of patents/applications older than a certain age; assignments that are anticipated could be filtered out, like: assignments of new patent applications to an existing patent holder; show interesting new assignments that may be suspicious; and assignments could be filtered by technology type/class/subclass.

In an embodiment, a tool is used for patent activity profiling. The tool may include the following features; a) build a patenting profile for a particular applicant/owner, or a type of owner, and then flag deviances from that profile; b) the profile may include foreign filing patterns, US filing patterns (e.g., does the owner typically file provisional first, then PCT, or PCT, US, etc. . . . , abandonments—e.g., what are they giving up on?; c) Show deviances from the profile, send out notifications; d) display filing profile for others to look at; e) this data would be assembled from public data.

In an embodiment, a tool is used to watch a competitor's prosecution. The tool may allow a user to set up an account on a web server/asp system that may pull in public PAIR files; Pick cases one at a time to add; Load cases for entire portfolio for owner and remove as desired; Specify owner, and have system automatically add new cases for owner; Automatically add related cases that are filed; Keep a list of suggested new cases to add based on: Locations of inventors; Patent counsel named on case; Class/subclass; Keywords; Cited art—i.e., if the case cites a patent from the user's company; PCT filings or other national stage claiming priority; Notify owner of account each time new suggested cases are added; Owner may keep or dismiss suggested accounts to watch; With respect to any PAIR file, user may: get notified each time there is a change; Get notified if case goes abandoned; If there is an office action; If prior art is filed.

In an embodiment, every time a U.S. patent issues, or the application publishes, a fan page is automatically set up on Facebook/social network. A tool may then search for owners of patent on Facebook/LinkedIn, and invite them to become a fan. An app on the Fan page may quote fees for payment of annuities or other services. Patent or app status may be updated from public data. Updates could be forward cites of patent. Updates could be allowance, grant, or rejection. Updates could be payment of maintenance fees.

In an embodiment, a tool may look at abandonment for competitor patents in same area respecting any particular maintenance fee decision. This may also be determined by: Class/subclass; Standard Industry Codes correlated to patents; Keywords; Semantic analysis.

In an embodiment, a tool is used for finding relevant web hits for watching patents. For a given watched patent the system may:

a. Keep a list of forward-cites

From the list of forward-cites, identify all the IP owners of the forward cites

c. Send watch notice each time new material is posted to the web site of an IP Owner that is relevant to the patent, based for example on keywords or a class/subclass concordance

d. Do the above for owners of the cited prior art.

In an embodiment, a tool is used for protect ownership of a patent and keep a patent in force, The tool may be implemented as website and include features of:

1. User goes to web site

2. User may pick any US (or where possible) any foreign patent/application. User may choose any one of the following automated protections

a. No assignment filed monitor:

i. Automatically check and report if no Assignment is filed for application within a given time frame

b. Assignment changed monitor:

i. Automatically check and report if Assignment is changed

c. Patent fee not paid—

i. automatically notify user if fee not paid

ii. kick in revival process if fee not paid

1. process might be notifying one or more law firms

2. process might include notifying agent for user

d.

“Troll Monitor/Metric

Owner Change Metric

This concept is to:

1. For any given patent/application

a. provide a rating/metric that indicates if ownership of related patents is changing

i. at a frequency above normal

ii. there are any changes at all

iii. for prior art patents

iv. for forward cited patents

v. for patents in class/subclass, as compared to other classes/subclasses

b. using a list of known trolls, or suspected trolls

i. determine level of troll activity in an area

ii. report level of activity

iii. use as metric to determine potential value of patent

In an embodiment, a tool is used to determine what classes/technologies a company has the best position in (e.g. by percent of class or subclass or by number of total cites). The tool may determine most open areas for a company based on existing filings—which areas show the most promise for patenting based on number of patents, timeline for class—e.g., how close to beginning of filings in the area.

In various example embodiments, a tool for strategic monitoring may be used to determine if there is a chance of infringement. The tool may:
1) Receive forward citations for a given patent;
2) Compare the text of the claims of the forward citation to the spec or claims of the given patent;
3) If the text of the claims of the given patent is all found, or mostly found, in the forward citation, then there is chance of infringement; In some example embodiment, the tool may measure the degree of overlap. In one example embodiment, if the overlap is strong in the abstract or claims, then a conclusion may be drawn that the overlap is core to the described technology.

In some example embodiments, a tool may be used to show counts of filings by owner (e.g., one chart for each year). In one example embodiment, to allow comparisons, the tool may show line graphs under a bar chart, each line representing an owner's trend line for filing. The tool may allow a user to enter one or more keyword combinations and perform proximity searches. In some example embodiments, the tool may display a histogram of patents meeting criteria by year.

In some example embodiments, a tool may be implemented to send report(s) each week on analytics, such as:

1. Gainers or losers for all owners in a class or subset in weekly, monthly, or quarterly filings;

2. Totals for all owners, or subset, for recent periods;

3. Filing trends in a class—bar chart/histogram by year, quarter, or month;

4. Broad patent report by class (e.g., look at length of claim).

In various example embodiments, a tool may be used to display a list of owners that have increased or decreased filings in a particular class. This tool may, in some example embodiment, rank the owners by percentage increase or decrease, or absolute number increase or decrease.

In some example embodiments, strategic monitoring is used to examine the “universe” of connected companies. A tool may be implemented to mine the degree of connection a company has to other companies. In various example embodiments, mining the relationships between a number of connected companies may be used in potential licensing negotiations or competitor analysis. This tool may be used to determine the degree of connection the company has and to sort on it. Also, this tool may be used to examine other attributes of the relationship, such as:

1) the degree that each company overlaps in classes in which it has patents;

2) the degree of growth or date of entry to a class that evidences new interest in a class of technology;

3) the overlap in key terms for the subject matter (e.g. invention) in question.

In one example embodiment, the tool may show all related owners for a patent. The tool may gather data from prior art references, forward, secondary, and tertiary cites, and label by type or degree of connections.

In some example embodiments, a strategic management tool may be used to identify troll patents. This tool may include the following features:

1) For each owner (e.g., assignee name), a company web site is identified. In one example embodiment, this may be determined by doing an automated or manual web search, or by searching a database of web sites to determine if the assignee has a web site;

2) If the owner has a web site, the web site is checked for analytics, for example, number of visitors, date established, and type of visitors;

3) The site may also be checked for hallmarks of a practicing entity or hallmarks of a non-practicing entity;

4) Ownership transfers may be checked to see if the patent has changed hands and what the name of acquiring company is. In one example embodiment, all acquiring companies that do not have a web site would be suspect.

5) Implement other ways to flag patents owned by companies with no apparent operating web presence.

In some example embodiments, a tool may be used to find the closest company profile by picking any profile and finding the closest company overall based on number of patents in all classes.

In some example embodiments, a tool may be used to determine the fastest growing or fastest declining owner in a class. In various example embodiments, the tool may be implemented to display the results in graphic form. In some example embodiments, the tool may have one or more of the following features:

1. For any picked class, show “fastest growing owner” in class by applications published or patents issued. In one example embodiment, this is displayed in terms of absolute numbers or percentage terms.

2. For any picked class, show “fastest declining owner” by absolute numbers or by percentage terms.

In various example embodiments, a tool may be used to correlate one company's patent(s) to another company's product(s). This tool may:

1. Map company A's patent(s) to company A's product(s) and/or marketing literature;

2. Correlate company A's product and/or marketing literature to company B's product and/or marketing literature. This may allow the tool to correlate company A's patents to company B's products. In one example embodiment, the tool may highlight key phrases or words in literature for each patent of company A.

In some example embodiments, a tool may correlate a patent to a product. This strategic monitoring tool may allow a user to map a patent X to competitor products. In one example embodiment, this tool may:

1. Take the product name and/or model for a product;

2. Perform a web search (e.g., using Google);

3. Scrape results and ads that match;

4. Sort through results to find competitor products and correlate patent X to the search results.

General Utility Tools

In some example embodiments, a tool may be used for lighting inside a purse. In an example embodiment, a flexible EL lighting or LED lighting strip may be fastened on the side of a purse, either by original manufacture design (e.g., a Velcro™ strip to attach a light to) or added later by fastening to side of purse by glue or other means.

In various example embodiments, the system described herein may allow a user to create a Group and make it unique. In one example embodiment, the Group may be used by Group members for group discussions around patent(s) or portfolios that the Group follows. In various example embodiments, to create a Group, a user designates a Portfolio (e.g., similar to My Portfolio) that the user may want to follow and discuss. Other users (e.g., group members) may sign up to follow the Portfolio (e.g., join the group). This may allow for creating Groups of a kind. In some example embodiments, patents or applications may be added to a Group. This may allow for the prominent display of patents. In various example embodiments, users may post up interesting patents or applications in a Group. In some example embodiments, the system may notify the Group and/or its members whenever an activity concerning the respective patent or application occurred (e.g., the status of the patent or application changed or it was cited).

In some example embodiments, the Patents tab may be made prominent to make it clear to a user on the Group page that the group (e.g., the group members) is following or commenting on a particular patent or portfolio of patents. In various example embodiments, the “My Portfolio” functionality is used to create one or more Portfolio(s) of patents to follow in the group. The system may allow the use of the Watch functionality to provide Watch functionality for any patent added to the Group. In some example embodiments, the Group may also watch and comment on patents or applications from any of the following:

1. Issued or published in a tech area;

2. Issued or published to a company.

For example, there may be a Group that is called “Company A Patent Group” that watches and/or comments on patents issued to Company A. Another example may be a Group that watches and/or comments on wireless patents.

In some example embodiments, the system may allow users to tag a patent or application:

1) tag it if they are an inventor—click to see their directory profile;

2) tag if they are an attorney/broker—see their directory profile.

In some example embodiment, this would be similar to having the patent in the user's patent portfolio on their directory page. In various example embodiments, if a user published the user's portfolio in the user's directory entry, a section may be added for each patent or application to indicate which users have the patent in their portfolio. In various example embodiments, the system may allow users to enter or choose a Role for each patent in their portfolio (e.g., drafted, licensed, supervised, or broker).

In various example embodiments, the system may allow registered users to create their own “My Portfolio”. The patents in this “My Portfolio” may be published to the user's Directory Profile. In various example embodiments, the following functionality may be available:

1) Users may Publish their My Portfolio (hereinafter, also “Portfolios”) in its entirety to a new Main tab element on the website;

2) These Portfolios may look and have the same features as My Portfolio; In some example embodiments, they may have the following additional features:
a) may name the portfolios, and describe them (e.g., similar to the groups);
b) users/owners of the Portfolio may post Status updates to the Portfolio;
c) users (e.g., registered users) may sign up to Follow Portfolios;
d) in user Dashboard, the system may publish New Portfolios of users, and users may sign up to follow them. In one example embodiment, any new developments in the Portfolios, like status updates, or new Forward Citations in a Portfolio, may appear in the Dashboard, if it is being followed.

In some example embodiments, a tool may be used to determine the earliest dates of applied or cited prior art to determine odds of broad invention. To perform this functionality, in one example embodiment, this tool may consider several different pools of prior art:

1. Art cited directly against a patent;

2. Art cited against a patent and art cited against that art;

3. Earliest patents in class.

In some example embodiments, a tool may be used for scope concept building. This tool may help mappers to find common concepts to map to multiple claims. In various examples, this functionality is implemented in a pop-up configuration.

1. In some example embodiments, the user may need to determine which concepts are common between different claims. For example, a user may read the claims in a patent to determine whether more than one claim has the scope concept (e.g., limitation) “sending the plurality of links through the limited communication interface”. To verify that the limitation was in the claims the way the user was reading them, the user may do a keyword search on the claims to determine whether all the keywords are present. If the user determines that several claims have these keywords and they are in the same location, the user may be assured that the scope concept maps to those claims.

2. In various example embodiments, a tool may be used to help the mapper with the task of identifying scope concepts shared by claims. In some example embodiments:
1. User may pick one patent to work in (e.g., by using the Paperclip function);
2. User may highlight a phrase in a claim;
3. System may generate (e.g., automatically) a list of keywords from the phrase, and displays a phrase, for example, “Draft Scope Concept: sending the plurality of links through the limited communication interface”; In various example embodiments, the system may show the smallest block of text that contains all the keywords in all the claims of the patent. If not all keywords are found in a claim, then the system may show the smallest block of text that contains all the keywords actually found in the claim (but, for example, highlighted with a different color than if all keywords are found).
4. System may show that these keywords are found in the claim from which the phrase was taken, and also the other claims the keywords were found in;
5. User may edit to stem or change keywords; For example, the user may stem “limited” to “limit”, or edit “communication” to “communication interface”; In one example embodiment, the user may add a keyword to the list or delete a keyword from the list. Keywords may be one or multiple words.
6. User may hit a “refresh” button and the system may recalculate the matching keyword columns and blocks of claim text containing the keywords;
7. User may edit Draft Scope Concept and refresh, to see what keywords (or stemmed keywords) it now has in the list;
8. User may Map the Draft Scope Concept to claims that contain all the keywords; In one example embodiment, if the user wants to map the Draft Scope Concept to a claim that does not contain all the keywords, the user may be warned (e.g., “Are you sure? Claim X does not contain all the keywords in the Draft Scope Concept.”)

In some example embodiments, a tool may be used for patent technology timeline dating. This tool may create an index of technology development or commercialization milestones that may be independent of the patent literature. For example, Wikipedia describes many milestone dates of major technology advancements or releases of products. In various example embodiments, analytics for a patent may involve viewing all milestones associated with a patent. If, for example, the patent has a priority date after the milestone, its potential value to cover that technology may be less than if the priority date was before the milestone. In some example embodiments, the system may assign scores to patents for date-relevance to milestones, with “late” patents getting a reduced score.

In various example embodiments, a tool may be implemented with the following features:

1) Annuity payment registry may keep list of patents from various countries that are available to be chosen by a user and paid by service.

2) In some example embodiments, users (e.g., clients/owners of patents) may not add patents or applications to the registry. In one example embodiment, only patents or applications that the registry has chosen to handle may be listed.

3) Patent owners or their representatives may go to the registry and pick patents or applications for:
a) scheduling of payments due;
b) amounts due;
c) reminders;
d) analytics;
e) getting instantaneous quotes or estimates;
f) having reminders with quotes sent;
g) verifying ownership;
h) watching for changes in ownership;

4) Owners may be responsible to pay online before any payments are made. Payments may be accepted in various ways.

5) In some example embodiments, certain patents applications may not be deliberately excluded from the registry based on one or more criteria, such as: technical area of patent (e.g. pharmaceutical or biotech that have high risk), or owners that are known to own high risk patents or are financially challenged, or known to be unreliable, or for which there is no information to qualify them. In some example embodiments, specific patents or applications may be excluded based on perceived high risk, or treated differently in terms of pricing or process used to verify nonpayment.

6) Users may be asked to provide at least a predefined minimum number of notification paths (e.g., multiple points of contact with both an email address and a physical address, telephone SMS). In one example embodiment, the contact information may require confirmation. In one example embodiment, to get certified mail, the users may be required to pay an additional amount.

7) In one example embodiment, users may only be allowed to mark an item Do Not Pay or deregister if they have a security code provided to them or that they provided (e.g., one based on challenge-response), or they otherwise confirm their credentials.

8) The system may also collect contact information for owners of patents on the registry whether or not the owners use the site, and the system may send reminders/notices for patents even if not a user of the site. These emails may include a list of patents or URL to view the owners' patents and allow owners to sign up to have the system monitors those payments.

9) In one example embodiment, the system may keep track of everything (e.g., as opposed to tracking patents only for a particular customer). In some example embodiments, the system may offer payment or notification services.

In various example embodiments, a tool may be used to show backward and forward citations on a time graph (e.g., with color coding for top owners). In some example embodiments, this tool may show an owner legend below the graph.

In some example embodiments, the importance of a target patent is rated by the longevity (e.g., number of annuities paid, continuations that claim priority to the target patent, or a combination thereof) of related patents. For example, the system may determine whether patents are either (1) cited by the examiner against a target patent or (2) cited more (e.g., most) frequently and related to the target patent in some way (e.g., keyword overlap, class or subclass similarity, forward/backward cites, or a combination thereof) are being abandoned or are being maintained. This information may be used to rate a patent generally, value a patent, such as in a dollar amount, or rate a patent for the likelihood of a maintenance renewal being paid for the patent.

In some example embodiments, a tool may be used to automatically determine the likely value (e.g., monetary or other value) of a target patent by analyzing statistics or concepts (e.g., phrases or keywords that define a technology area covered by the claims, specification, and/or abstract of the patent), or both. More specifically, for a target patent, using the cited and applied art, the system may mine forward/backward art based on applied art (e.g., may do several iterations until a target number of patents are found). The system may gather patent documents cited in the prosecution history of the target patent and mine patent documents with a forward/backward cite to the patent documents cited in the prosecution history of the patent document.

The system may graph mined patens by year or owner (e.g., similar to the Cited Art shown in a patent profile). The system may find most relevant earlier patent, for instance, by looking for some correlations between the mined patent and the target patent based on keyword overlap, owner (e.g., assignee) overlap, subclass overlap, or other means. The system may calculate one or more scores or generate one or more graphs using this data to determine the pioneering nature of the target patent. The system may show the degree of keyword similarity from this set of patents, such as year by year, or some other means, such as color coding, or one bar or line point per year based on number of references and the other bar or line point per year representing percentage of keyword overlap in that year.

In some example embodiments, a time-decay claim scope evaluator tool may be used for analyzing and evaluating the claim scope breadth of a subject patent, issued or pending. According to some example embodiments, a user interface is provided for one Claim Scope Evaluator where a user enters, searches, or selects a subject patent, issued or pending, for claim scope evaluation. The tool may search for prior art to the subject patent or calculate a claim scope rating for the subject patent. The consolidated claim scope rating may be displayed to the user or may be output to a report.

When analyzing a patent document it may be beneficial to find out what the scope, or breadth, of the claims is. Evaluating claim scope by reading and construing each claim takes a significant amount of time and effort by a skilled professional. Information about other patent documents may have a strong correlation with the subject claims' scope. The time-decay claim scope evaluator tool may calculate claim scope rating information describing a patent's or application's potential claim scope. Claim scope rating may be derived and calculated from information about other patent documents, as well as non-patent publications within a technology area. A patent document may include a patent or a patent application.

When a new patent application is filed for an invention, the potential scope breadth of the application's claims may be determined by the prior art. In the case where there is minimal or no prior art the patent application may present broad claims for the invention. In the case where there is already substantial prior art the invention is constrained by the prior art, and therefore may be forced to formulate more narrow claims. An issued patent with broad claims is more desirable than an issued patent with narrow claims because broad claims confer a broader exclusivity to practice the invention.

When working with patent documents it may be important to quickly and easily analyze and understand whether a patent or patent application has the potential for broad scope or for narrow scope. For patents, quick and easy scope analysis may be important for evaluating the relative scope of a patent and also for evaluating the aggregate scope of a set of patents. For patent applications, quick and easy scope analysis may be important for prioritizing and preparing invention related documents before filing a patent application. These priorities and preparations include but are not limited to choosing subjects for research and development, choosing invention disclosures for preparing patent applications, and for writing the patent application. This sort of analysis is often called a “white space” analysis.

The potential scope of a patent claim may be broad if there is only minimal or no prior art in the technology area. If, on the other hand, a prior art investigation reveals that the invention is found in the same technology area as many other prior patent documents in the same technology area, the potential scope of new patent claims may be quite narrow as compared to a case with minimal or no prior art. Generally, but not always, the later an invention is made within a technology area the narrower its claims will become, because there has been more time for others to innovate in the technology area and file patent documents or other publications regarding the technology area.

“Invention art context” is defined as one certain body of art which is found when performing a certain prior art search for one invention. “Invention space” is defined, at each point in time for one technology, as potential inventions that may be patented and that are not anticipated by prior art.

For a given invention art context the inventive space that may be made subject for patent filing may be consumed over time by disclosures. The first patent in an invention art context has few limitations with regard to the disclosures. Every subsequent patent document is generally written within the constraints defined by all previous disclosures (e.g., patent documents or other publications or sales in the technology area).

For the first patent in an invention art context there exists no patent prior art and mostly no or only minimal non-patent art in the form of non-patent publications. Patents filed subsequent to the first patent, but close in time to the first patent, are anticipated by the teaching of the preceding patents in the patent art context time and sequence, while succeeding patent applications are constrained by all previous disclosures. The later the application is filed the more constrained it is with respect to potential claim scope.

When products or product announcements based on an invention are first launched within a technology area, particularly when these products become commercially successful, there may be an increase in disclosures. This effect generally reduces the opportunity to acquire broad claims in the technology area.

For inventions and technologies, a general, repeatable sequence is found. Generally, a first original invention leads to a first patent application with broad claims. Several subsequent applications on inventions follow with narrower claims due to the disclosure of the first invention, particularly when the original invention's patent filing and its prosecution have been performed to maximize claim or disclosure scope. Generally, the later in time and sequence an application in the invention art area is made, the narrower the claims. After an original innovation's commercial launch, an increase of public disclosures, particularly non-patent publications, is found because the broader public becomes aware of the invention art area. Subsequent inventions within the technology lead to patent applications with comparatively narrow claims because the scope of claims for these inventions becomes restricted by a larger number of preceding disclosures.

In short, early inventions and filings within an invention art context are desirable because of their broad claim scope potential. The narrower scope of later filings in the invention art context makes these patents less valuable due to the reduced exclusionary rights provided by the generally narrower claims. The potential scope breadth for claims narrows the later the patent applications have been filed relative to the first invention in the technology.

The analysis of the claim scope breadth may be dependent on the invention art context as defined by the body of preceding disclosures that has been found through a search and may be included in the analysis. An example showing that claim scope is relative to the scope of technology area is provided for convenience. Consider an application that discloses a particular method for using low power when calculating the position of a mobile computing device. A patent for this invention may have relatively broad claims if this is the first patent disclosing this way of reducing power consumption for GPS calculation. The phrase “GPS position devices for mobile use” (low power required) is considered the invention art context for analysis. A patent for the same invention may at the same time be considered to have relatively narrow claims when the invention art context to be considered is “applications within mobile computing devices” because this is a much broader technology area. Thus, claim scope rating is dependent on the scope of the technology within which it is evaluated. This scope is the invention art context.

Evaluation may be made within the UI of a “Claim Scope Evaluator”. Evaluation of claim scope may be done against the body of disclosures preceding the subject patent within the invention art context. A subject patent is analyzed for potential scope breadth, considering an invention art context. The invention art context is defined by a search of disclosures to be considered, such as can be based on keywords or phrases from a user or extracted automatically from a patent document.

In some example embodiments, a tool that displays cited art and forward cites for a patent includes a similarity score for each cited reference and forward cite. The similarity score may be based on the number of similar keywords found in the patent document of interest and the prior art patent document. For example, the system may isolate (or identify) a plurality of keywords in the specification, the claims, or the abstract, or a combination thereof of the patent of interest, and count how many of those keywords are found in each of the cited art documents or forward cited art documents. This tool may help users determine which cited art or forward cited patents, and owners, were more important or relevant to the patent of interest. This similarity calculation or index may be used to create a list of patents that are similar to the patent of interest.

In some example embodiments, an analytics tool for managing a portfolio generates the portfolio and presents it to a client. To automatically identify core concepts a list of most relevant keywords or Boolean combinations of keywords (e.g., phrases) may be specified. To automatically identify core concepts a Portfolio may be “seeded” by loading a set of patents, for example, from a prior art search and targeting the key concepts, such as by determining keywords or concepts that appear most often in the “seeded” documents. In some example embodiments, “relevance” of patents or “source” of patents loaded may be tagged (e.g., with a “Prior Art Search” tag or an “early/pioneering” tag). The tags may be used later to help with automated analysis.

In certain example embodiments, a closest subclass designation, a list of known competitors, or a time frame known to bracket or center the pioneering work in the field to which the invention pertains may be specified. An algorithm may be executed to find related patent documents. The algorithm may use, for example, keyword/concept analysis, forward-backward cites, identification(s) of classes, or identification(s) of competitors to find related patent documents.

These patent documents may populate the Portfolio. Using the Portfolio as is, analytics (e.g., competitors, timelines, or top patents) may be generated. Alternately or in addition, the Portfolio may be triaged/filtered down further, as follows, such as before analytics are run. Filtering may include going through all patents one by one and tagging relevant, irrelevant, or possibly relevant patents. Filtering may include archiving or dismissing irrelevant or possibly relevant patent documents. Filtering may include identifying (e.g., automatically) patents by importance (e.g. according to some metric that finds likely important patent documents). In some example embodiments, this may be performed by automatically flagging patent documents that have relatively early priority dates, multiple continuations, a strong keyword relevance, or a combination thereof. Filtering may include analyzing at a list of keywords entered or mined from the patents, and indicating relevance of those alone or in combination, to help refine patent document selection criteria.

In certain example embodiments, a user, using a wizard-type structure may seed a portfolio with best known prior art patent documents (e.g., kept in a separate list) or identify the most important keywords or concepts mined from those patent documents. The user, using the wizard, may add own keywords or combinations of keywords, identify key competitors, or identify a timeframe of the earliest known products/technology in the field, if possible.

The system may (e.g., automatically, such as without human interference or based on user input, such as input provided through the wizard) generate a pool of relevant patent documents, rank the pool by perceived importance of patent documents using one or more algorithms, or generate analytics (e.g., the number of patents per owner, timeline, importance, or any other analytics that may be run on a portfolio).

In some example embodiments, a prosecution analytics tool for managing prosecution and analyzing portfolios may allow a prosecutor or analyst to determine, such as in a quick fashion, how dense or close the prior art is to a technology. References that share a large number of important keywords with the subject matter of a patent document may be considered important or relevant. The tool for prosecution analytics may correlate a statistical uniqueness measurement with a probability of success in ongoing prosecution (or later as a way to analyze portfolios).

Using any one of a number of possible techniques, a “uniqueness” measure for a target patent application is determined. For example, based on keyword or concept prevalence in prior art, one or more keywords may be automatically selected from a target, or manually selected or specified. The prior art could include prior patents, patent applications, or other documents, or an expanded pool of art using any technique.

The prosecution analytics tool may allow for using counts of prior patents or applications in the same class or using another automated measure for the “uniqueness”. The prosecution analytics tool may display or use the analytics in a variety of ways, such as may include correlating the uniqueness measurement to a probability of allowance or rejection, for example, based on analyzing historical PAIR data, correlating the uniqueness measurement with a chance for obtaining a broad claim, or judging a uniqueness for the application as a whole, or on a claim by claim basis. The prosecution analytics tool may determine whether there is unclaimed subject matter, judge uniqueness for any particular keyword, or determine a “crowdedness” measure that determines statistically how crowded the art is. The prosecution analytics tool may rank references, such as in terms of a likely difficulty to overcome or analyzing a portfolio for best patents or, in the case of pending applications, possibility for patenting.

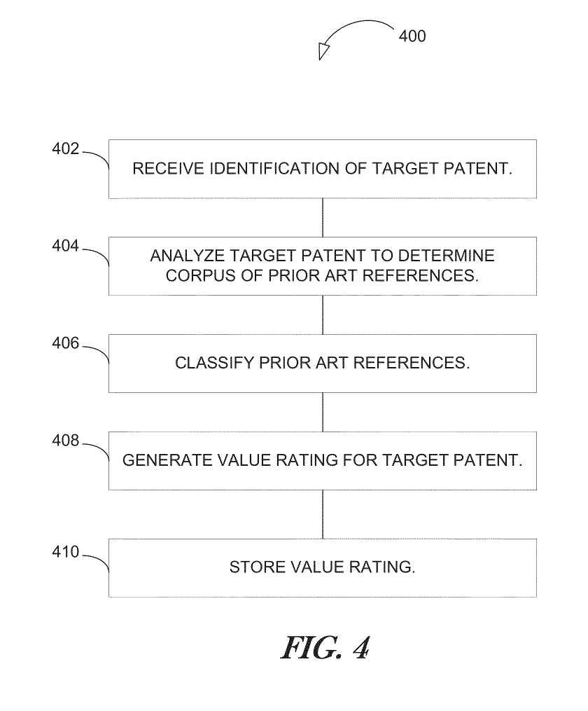

FIG. 4 illustrates a method, which may be performed by the modules, components, and systems described herein, to rate a target patent, according to an example embodiment. 400 illustrates: receiving an identification of a target patent at operation 402, analyzing the target patent to determine a corpus of prior art references cited against the target patent at operation 404; classifying a plurality of the prior art references in the corpus of prior art references as abandoned or active at operation 406; generating a value rating for the target patent based in part on the classifying at operation 408; and storing the value rating in association with the target patent at operation 410.

In an example, at operation 402, a user may be presented with a user interface of a patent management system, such as patent management system 102. The interface may include an input box to enter an identification of a target patent. The identification may be a patent application number or a number of an issued patent. In various examples, a standalone tool may be used to perform the method 400 or another method discussed herein.

In an example, operation 404 in which the target patent is analyzed, includes retrieving a listing of patent documents that were cited against the target patent. For example, an application programming interface call may be made to a remote server (e.g., separate from the patent management system 102) to retrieve the cited prior art references. In other examples, Optical Character Recognition (OCR) may be performed on a target patent document or the cited prior art references may be retrieved from a database (e.g., a previous analysis of the patent document may have already been completed). A list of the prior art references may be grouped into a corpus of prior art references.

In an example, at operation 406, a plurality of the corpus of prior art references may be classified as abandoned or active. In an example, the classification may be determined by transmitting a request to the USPTO website or via an API call to a remote server. In an example, the classification may be retrieved from a database local to the patent management system. In various examples, abandoned means a notice of abandonment has been issued for a patent application or a patent has lapsed due to lack of maintenance fee payment. Active may mean that a patent application is currently being prosecuted, is currently in force, or has expired. Thus, even though a patent may no longer have enforceable rights, the patent document may be classified as active for purposes of a value rating. In an example, a user may set a preference indicating expired patents are classified as abandoned.

In an example, at operation 408, the value rating of the target patent is determined based in part on the classifying. For example, the ratio of abandoned to active patents may be calculated in the corpus of prior art references. Depending on the ratio, a qualitative (e.g., low, medium, high) or quantitative (on a scale of 1-10) rating may be determined. The scale may be set as a preference as compared to the ratio. For example, if the ratio indicates that 75% of the prior art references in the corpus are active, the value rating may be high. In various examples, the value rating may correspond to a recommendation to pay or not pay upcoming maintenance fees. Similarly, the value rating may correspond to likelihood that a current patent owner will pay upcoming maintenance fees. In various examples, the value rating is stored as associated with the target patent at operation 410.

In various examples, the value rating may be based on or modified according to a comparison corpus of patent references. There may be overlap between the corpus of cited prior art references and comparison corpus, according to various example embodiments. In an example, the patent documents to select for use in the comparison corpus may be determined by examining similarities between a potential patent document to include in the comparison corpus and the target patent. The similarities may be based on, but not limited to, keyword overlap, classification, forward/backward cites, and combinations thereof).

Similarly, a validity rating for a patent document may be generated by comparing the pool of cited prior art references to the corpus of patent documents retrieved. A patent is more likely to be valid if the pool of prior art references includes the corpus of patent references that include a filing date or invention date prior to the filing or invention date of the target patent. A similarity score between a prior art document that is not in the pool of cited art and the entire contents of the prior art can be generated. If the similarity score indicates that the prior art is merely cumulative (e.g., the similarity between the non-cited prior art document and the pool of cited art is high), then the target patent can be more likely to be considered valid. If the similarity score indicates that the prior art is not merely cumulative, a comparison of a “novelty” (e.g., a keyword(s) that captures the novelty) of the target patent can be compared to the non-cited prior art to determine a likelihood that the novelty was present in the non-cited prior art. In this fashion, a quick validity analysis can be automatically determined.

When comparing keywords, the system can consider synonyms, phonetically similar words, or related words to the keyword(s) in determining a similarity or other calculation.

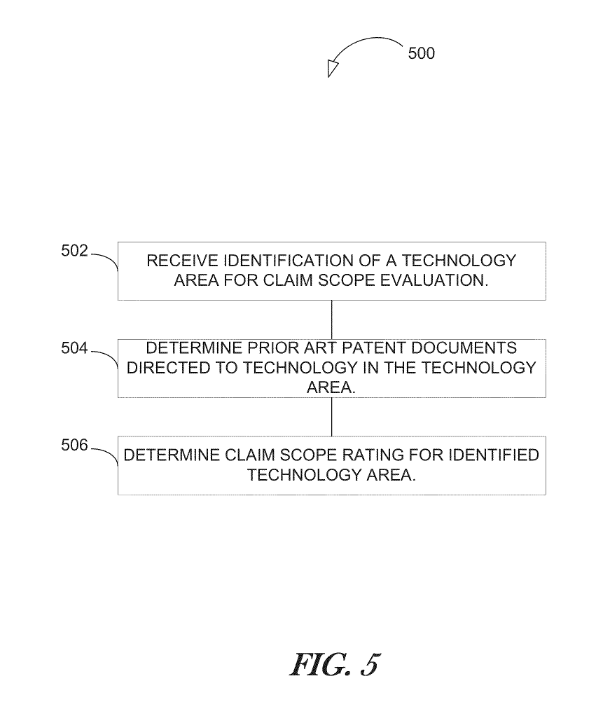

FIG. 5 illustrates a method 500, which may be performed by the modules, components, and systems described herein, to rate a target patent, according to an example embodiment. 500 illustrates: receiving an identification of a technology area for claim scope evaluation at operation 502, determining prior art patent documents (e.g., patent applications or issued patents) directed to technology in the technology area at operation 504; and determining a claim scope rating at operation 506.

In an example, at operation 502, a user may be presented with a user interface of a patent management system, such as patent management system 102. The interface may include an input box to enter an identification of a target patent document. The identification may be patent application number, the number of the issued patent, or one or more keywords which define the technology area. In various examples, a standalone tool may be used to perform method 500.

In an example, at operation 504, in which prior art patent documents directed to technology in the technology area, includes retrieving a listing of patent documents that include a keyword that defines the technology area. The technology area may be defined by a patent document and the prior art documents may include documents cited against the target patent document (forward cite) or patent documents that cite the target patent document (backward cite). For example, an application programming interface call may be made to a remote server (e.g., separate from the patent management system 102) to retrieve the prior art documents. In other examples. OCR may be performed on target patent document or the cited prior art references may be retrieved from a database (e.g., a previous analysis of the patent document may have already been completed). A quantity of prior art documents may be determined. An earliest filing date or earliest priority date of the retrieved prior art documents may be determined.

In an example, at operation 506, in which a claim scope rating is determined for the technology area (e.g., as defined by keywords or a patent document) may be determined based on the determined quantity of prior art patent documents, such as by determining a number of patent applications that have been filed in a specific patent class. The claim scope rating may be determined based on the earliest filing date or earliest priority date of the prior art documents. The claim scope rating indicates generally a breadth of claims that could be attained in the technology area. Generally, a claim scope rating may be greater the fewer prior art documents that are determined to exist. Generally, the claim scope rating may be lower the earlier the earliest priority date or earliest filing date that is determined. The claim scope rating may indicate a likelihood of getting a patent application issued with claims directed to the technology area based on the quantity of patent documents. The claim scope rating may be based on a number of occurrences of a keyword associated with the technology area appearing in the prior art documents.

The method 500 may include generating a visual depiction of the results of the method 500. This may include generating or displaying a graph of keyword similarity or number of patent documents versus time based on the determined patents documents. The graph may be color coded so as to help a user ascertain the information being presented easier. The method 500 may include determining if unclaimed subject matter in the prior art patent documents or what the unclaimed subject matter in the prior art patent documents includes. Such an analysis may help ascertain whether a technology in a technology area has been disclosed but not claimed. Such subject matter is generally not patentable.

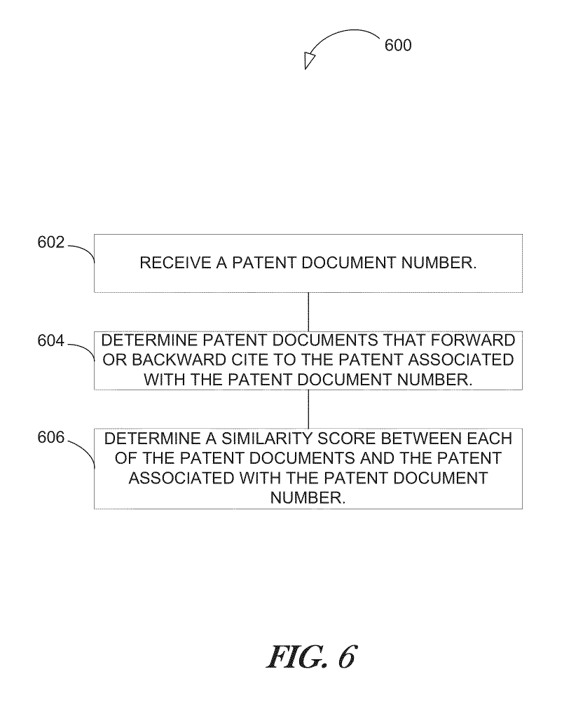

FIG. 6 illustrates a method 600, which may be performed by the modules, components, and systems described herein, to determine a similarity score, according to an example embodiment. 600 illustrates: receiving a patent document number at operation 602, determining patent documents that forward cite (e.g., a citation from an earlier document to a later document that generally results from a backward cite in which the relation to the later document is recorded) or backward cite (i.e. a citation in a later document to a previous document) to the patent associated with the patent document number at operation 604; and determining a similarity score between each of the patent documents and the patent associated with the patent document number at operation 606. The operation at 606 may include determining the similarity score based on a number of occurrences of a plurality of keywords in the claims, specification, abstract, or a combination thereof of each of the patent documents (e.g., that forward cite or backward cite to the patent associated with the patent document number) and the patent corresponding to the patent document number. The keywords may be provided by a user or automatically determined, such as by a processor.

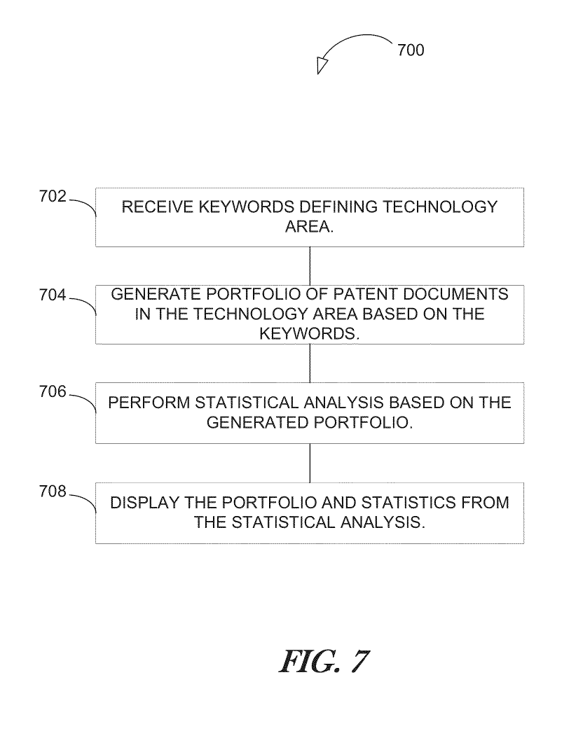

FIG. 7 illustrates a method 700, which may be performed by the modules, components, and systems described herein, to rate a target patent, according to an example embodiment. 700 illustrates receiving keywords defining a technology area at operation 702, generating a portfolio of patent documents in the technology area based on the keywords at operation 704; performing a statistical analysis based on the generated portfolio at operation 706; and displaying the portfolio and statistics from the statistical analysis at operation 708.

The operation at 702 may include receiving patent documents known to be in the technology area, such as from a user through a UI or automatically from mining a database or other patent document store. The operation at 702 may include generating the portfolio of patent documents based on a specified subclass of the technology, a specified company known to operate in the technology area, a time frame that specifies a start time and end time in which the patent documents are to be filed between, a patent document that cites to a patent known to be in the technology area, a patent document cited by a patent known to be in the technology area, or a combination thereof.

The operation at 704 may include determining an entity operating in the technology area or determining a relevant patent document list that details the most statistically relevant patent documents in the technology area. The operation at 704 may include comparing a number of occurrences of one or more keywords in a patent document to a threshold to determine a likely relevance of the patent document. The operation at 704 may include comparing a number of occurrences of one or more keywords in a patent document to a number of occurrences of the keywords in other patent documents of the portfolio.

The method 700 may include tagging each of the patent documents to indicate whether the patent document was received from a user or to indicate a relevance of the patent document. Relevance tags may include a number indicating the relative relevance of the patent document (e.g., on a scale of 1-10), a word tag indicating the relative relevance, such as “very relevant”, “relevant”, “possibly relevant”, or “irrelevant”, among others. The method 700 may include filtering the portfolio of patent documents to reduce the number of patent documents in the portfolio. Filtering the patent documents may include comparing a tag to a specified threshold (e.g., a predetermined threshold or a threshold specified by a user, such as through a UI) and removing the patent document if it is less than (or equal to) the threshold. Filtering the portfolio includes removing statistically irrelevant patent documents, such as by comparing a statistic provided at operation 706 to a threshold and removing the patent document if the statistic does not meet or exceed the threshold. The method 700 may include ranking each patent document of the portfolio of patent documents based on a prevalence of the keywords in the patent document, a filing date of the patent document, a priority date of the patent document, an owner of the patent document, or the number of continuations filed based on the patent document.

An operation of the method 400, 500, 600, or 700 can be combined with an operation of any of the other methods 400, 500, 600, 700.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

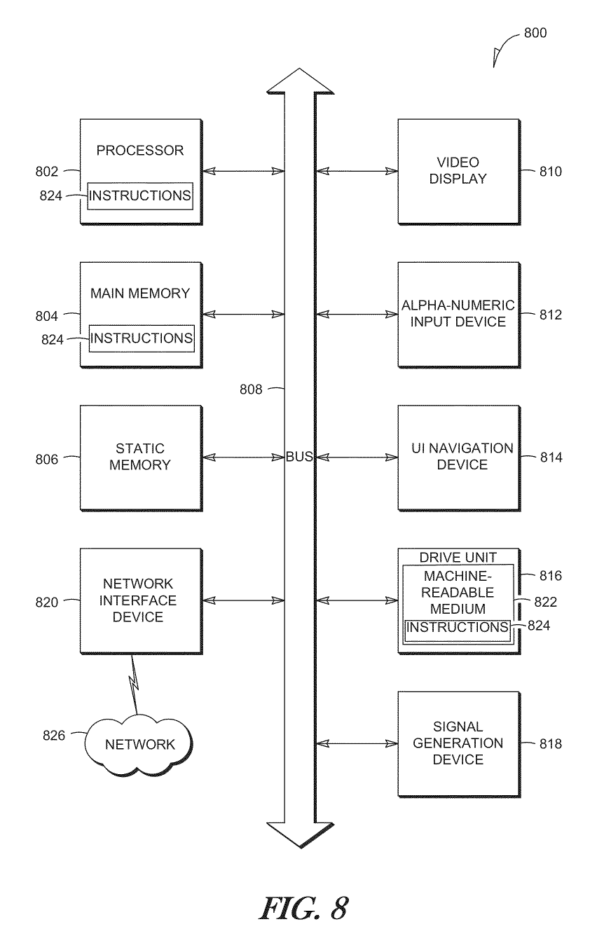

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g. a speaker) and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices. e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Various embodiments have been described using ordered elements (1), (2), etc. These elements are not to be taken in a limiting sense and other orders of operation may also be used.

### EXAMPLES

The present subject matter can be described by way of several examples.

Example 1 can include or use subject matter (such as an apparatus, a method, a means for performing acts, or a device readable memory including instructions that, when performed by the device, can cause the device to perform acts), such as can include or use receiving an identification of a target patent, analyzing the target patent to determine a corpus of prior art references cited against the target patent, classifying a plurality of references in the corpus of prior art references as abandoned or active, generating a value rating for the target patent based in part on the classifying, or storing the value rating in association with the target patent.

Example 2 can include or use, or can optionally be combined with the subject matter of Example 1, to include or use calculating a ratio between references in the corpus that were classified as abandoned and between references in the corpus that were classified as active, or basing the value rating on the ratio.

Example 3 can include or use, or can optionally be combined with the subject matter of at least one of Examples 1-2, to include or use generating a maintenance renewal recommendation based on the value rating for the target patent.

Example 4 can include or use, or can optionally be combined with the subject matter of at least one of Examples 1-3, to include or use generating a comparison corpus of patent documents associated with the target patent, classifying a plurality of references in the comparison corpus of patent documents as abandoned or active, or updating the value rating for the target patent based in part on the classifying the plurality of references in the comparison corpus of patent documents.

Example 5 can include or use, or can optionally be combined with the subject matter of Example 4, to include or use selecting patent documents to include in the comparison corpus of patent documents based in part on a comparison between prior art references cited against the target patent and prior art references cited against a potential patent document to include in the comparison corpus.

Example 6 can include or use, or can optionally be combined with the subject matter of at least one of Examples 4-5, to include or use selecting patent documents to include in the comparison corpus of patent documents based in part on a comparison between a classification of the target patent and a classification of a potential patent document to include in the comparison corpus.

Example 7 can include or use, or can optionally be combined with the subject matter of at least one of Examples 4-6, to include or use selecting patent documents to include in the comparison corpus of patent documents based in part on a comparison between keywords of the target patent and keywords of a potential patent document to include in the comparison corpus.

Example 8 can include or use subject matter (such as an apparatus, a method, a means for performing acts, or a device readable memory including instructions that, when performed by the device, can cause the device to perform acts), such as can include or use receiving an identification of a technology area for evaluation, determining prior art patent documents that are directed to technology in the technology area, or determining a claim scope rating for the identified technology area based on the determined prior art patent documents, wherein the claim scope rating indicates generally a breadth of claims that could be attained in the technology area.

Example 9 can include or use, or can optionally be combined with the subject matter of Example 8, to include or use, wherein determining the claim scope rating includes determining how many of the prior art patent documents include one or more keywords associated with the technology area therein.

Example 10 can include or use, or can optionally be combined with the subject matter of at least one of Examples 8-9, to include or use determining an earliest filing date for a patent document of the determined prior art patent documents or wherein determining the claim scope rating includes determining the claim scope rating based on the earliest filing date.

Example 11 can include or use, or can optionally be combined with the subject matter of at least one of Examples 8-10, to include or use determining an earliest priority date for a patent document of the determined prior art patent documents, or wherein determining the claim scope rating includes determining the claim scope rating based on the earliest priority date.

Example 12 can include or use, or can optionally be combined with the subject matter of at least one of Examples 8-11, to include or use, wherein receiving the identification of the technology area includes receiving a patent application number or issued patent number and determining the prior art patent documents that are directed to technology in the technology area includes determining a quantity of patent documents that include a keyword in the patent document associated with the patent application number or issued patent.

Example 13 can include or use, or can optionally be combined with the subject matter of at least one of Examples 8-12, to include or use, generating a graph of keyword similarity or number of patent documents versus time based on the determined patents documents.

Example 14 can include or use, or can optionally be combined with the subject matter of at least one of Examples 8-13, to include or use, wherein determining the prior art patent documents that are directed to technology in the technology area include determining patent documents that include forward and backward citations to the patent application number or the issued patent number.

Example 15 can include or use, or can optionally be combined with the subject matter of at least one of Examples 8-14, to include or use, wherein the claim scope rating indicates a likelihood of getting a patent application issued with claims directed to the technology area based on the prior art patent documents.

Example 16 can include or use, or can optionally be combined with the subject matter of at least one of Examples 8-15, to include or use, wherein the claim scope rating is based on a number of occurrences of a keyword associated with the technology area appearing in the prior art documents.

Example 17 can include or use, or can optionally be combined with the subject matter of at least one of Examples 8-16, to include or use, wherein determining the prior art patent documents that are directed to technology in the technology area includes determining a number of patent applications that have been filed in a specific patent class.

Example 18 can include or use, or can optionally be combined with the subject matter of at least one of Examples 8-17, to include or use, determining unclaimed subject matter in the prior art patent documents.

Example 19 can include or use subject matter (such as an apparatus, a method, a means for performing acts, or a device readable memory including instructions that, when performed by the device, can cause the device to perform acts), such as can include or use receiving a patent document number, determining patent documents that cite to the patent corresponding to the patent document number, or determining a similarity score between each of the patent documents that cite to the patent corresponding to the patent document number and the patent corresponding to the patent document number.

Example 20 can include or use, or can optionally be combined with the subject matter of Example 19, to include or use, wherein the similarity score is determined based on a number of occurrences of a plurality of keywords in the claims, specification, abstract, or a combination thereof each of the patent documents that cite to the patent corresponding to the patent document number and the patent corresponding to the patent document number.

Example 21 can include or use, or can optionally be combined with the subject matter of at least one of Examples 19-20, to include or use, wherein the keywords are provided by a user or automatically determined buy a processor.

Example 22 can include or use subject matter (such as an apparatus, a method, a means for performing acts, or a device readable memory including instructions that, when performed by the device, can cause the device to perform acts), such as can include or use receiving a patent document number, determining patent documents cited in the prosecution history of the of the patent corresponding to the patent document number, or determining a similarity score between each of the patent documents cited in the prosecution history of the patent corresponding to the patent document number and the patent corresponding to the patent document number.

Example 23 can include or use, or can optionally be combined with the subject matter of Example 22, to include or use, wherein the similarity score is determined based on a number of occurrences of a plurality of keywords in the claims, specification, abstract, or a combination thereof of each of the patent documents cited in the prosecution history of the patent corresponding to the patent document number and the patent corresponding to the patent document number.

Example 24 can include or use, or can optionally be combined with the subject matter of at least one of Examples 22-23, to include or use, wherein the keywords are provided by a user or automatically determined by a processor.

Example 25 can include or use subject matter (such as an apparatus, a method, a means for performing acts, or a device readable memory including instructions that, when performed by the device, can cause the device to perform acts), such as can include or use receiving a plurality of keywords defining a technology area, generating a portfolio of patent documents in the technology area based on the keywords, performing a statistical analysis based on the generated patent documents, and displaying the portfolio of patent documents and statistics from the statistical analysis.

Example 26 can include or use, or can optionally be combined with the subject matter of Example 25, to include or use, wherein generating a portfolio of patent documents includes receiving patent documents known to be in the technology area.

Example 27 can include or use, or can optionally be combined with the subject matter of at least one of Examples 25-26, to include or use tagging each of the patent documents to indicate whether the patent document was received from a user or to indicate a relevance of the patent document.

Example 28 can include or use, or can optionally be combined with the subject matter of at least one of Examples 25-27, to include or use, wherein generating a portfolio of patent documents includes generating the portfolio of patent documents based on a specified subclass of the technology, a specified company known to operate in the technology area, a time frame that specifies a start time and end time in which the patent documents are to be filed between, a patent document that cites to a patent known to be in the technology area, or a patent document cited by a patent known to be in the technology area.

Example 29 can include or use, or can optionally be combined with the subject matter of at least one of Examples 25-28, to include or use, wherein performing a statistical analysis based on the generated patent documents includes determining an entity operating in the technology area or determining a relevant patent document list that details the most statistically relevant patent documents in the technology area.

Example 30 can include or use, or can optionally be combined with the subject matter of at least one of Examples 25-29, to include or use filtering the portfolio of patent documents to reduce the number of patent documents in the portfolio.

Example 31 can include or use, or can optionally be combined with the subject matter of Examples 30, to include or use, wherein filtering the portfolio includes removing statistically irrelevant patent documents.

Example 32 can include or use, or can optionally be combined with the subject matter of at least one of Examples 25-31, to include or use ranking each patent document of the portfolio of patent documents based on a prevalence of the keywords in the patent document, a filing date of the patent document, a priority date of the patent document, an owner of the patent document, or the number of continuations filed based on the patent document.

What is claimed is:

1. A method comprising:
receiving an identification of a target patent;
analyzing the target patent to determine a corpus of prior art references cited against the target patent;
classifying a plurality of references in the corpus of prior art references as abandoned or active;
generating a value rating for the target patent based in part on the classifying; and
storing the value rating in association with the target patent.

2. The method of claim 1, wherein generating a value rating for the target patent based on the classifying comprises:
calculating a ratio between references in the corpus that were classified as abandoned and between references in the corpus that were classified as active; and
basing the value rating on the ratio.

3. The method of claim 2, further comprising:
generating a maintenance renewal recommendation based on the value rating for the target patent.

4. The method of claim 1, further comprising:
generating a comparison corpus of patent documents associated with the target patent;
classifying a plurality of references in the comparison corpus of patent documents as abandoned or active; and
updating the value rating for the target patent based in part on the classifying the plurality of references in the comparison corpus of patent documents.

5. The method of claim 4, further comprising:
selecting patent documents to include in the comparison corpus of patent documents based in part on a comparison between prior art references cited against the target patent and prior art references cited against a potential patent document to include in the comparison corpus.

6. The method of claim 4, further comprising:
selecting patent documents to include in the comparison corpus of patent documents based in part on a comparison between a classification of the target patent and a classification of a potential patent document to include in the comparison corpus.

7. The method of claim 4, further comprising:
selecting patent documents to include in the comparison corpus of patent documents based in part on a comparison between keywords of the target patent and keywords of a potential patent document to include in the comparison corpus.

8. A non-transitory computer readable storage device including instructions stored thereon, which, when executed by a machine, cause the machine to perform operations comprising:
receiving an identification of a target patent;
analyzing the target patent to determine a corpus of prior art references cited against the target patent;
classifying a plurality of references in the corpus of prior art references as abandoned or active;
generating a value rating for the target patent based in part on the classifying; and
storing the value rating in association with the target patent.

9. The storage device of claim 8, wherein the instructions for generating a value rating for the target patent based on the classifying include instructions, which, when executed by the machine, cause the machine to perform operations comprising:
calculating a ratio between references in the corpus that were classified as abandoned and between references in the corpus that were classified as active; and
basing the value rating on the ratio.

10. The storage device of claim 9, further comprising instructions stored thereon, which, when executed by a machine, cause the machine to perform operations comprising:
generating a maintenance renewal recommendation based on the value rating for the target patent.

11. The storage device of claim 8, further comprising instructions stored thereon, which, when executed by a machine, cause the machine to perform operations comprising:
generating a comparison corpus of patent documents associated with the target patent;
classifying a plurality of references in the comparison corpus of patent documents as abandoned or active; and
updating the value rating for the target patent based in part on the classifying the plurality of references in the comparison corpus of patent documents.

12. The storage device of claim 11, further comprising instructions stored thereon, which, when executed by a machine, cause the machine to perform operations comprising:
selecting patent documents to include in the comparison corpus of patent documents based in part on a comparison between prior art references cited against the target patent and prior art references cited against a potential patent document to include in the comparison corpus.

13. The storage device of claim 11, further comprising instructions stored thereon, which, when executed by a machine, cause the machine to perform operations comprising:
selecting patent documents to include in the comparison corpus of patent documents based in part on a comparison between a classification of the target patent and a classification of a potential patent document to include in the comparison corpus.

14. The storage device of claim 11, further comprising instructions stored thereon, which, when executed by a machine, cause the machine to perform operations comprising:
selecting patent documents to include in the comparison corpus of patent documents based in part on a comparison between keywords of the target patent and keywords of a potential patent document to include in the comparison corpus.

15. A system comprising:
a first module configured to:
receive an identification of a target patent;
analyze the target patent to determine a corpus of prior art references cited against the target patent;
classify a plurality of references in the corpus of prior art references as abandoned or active; and
generate a value rating for the target patent based in part on the classifying; and
a second module configured to store the value rating in association with the target patent.

16. The system of claim 15, wherein the first module configured to generate a value rating for the target patent based on the classifying comprises the first module configured to:
calculate a ratio between references in the corpus that were classified as abandoned and between references in the corpus that were classified as active; and
base the value rating on the ratio.

17. The system of claim 16, wherein the first module is further configured to:
generate a maintenance renewal recommendation based on the value rating for the target patent.

18. The system of claim 15, wherein the first module is further configured to:
generate a comparison corpus of patent documents associated with the target patent;
classify a plurality of the prior art references in the comparison corpus of patent documents as abandoned or active; and
update the value rating for the target patent based in part on the classifying the plurality of references in the comparison corpus of patent documents.

19. The system of claim 18, wherein the first module is further configured to:
select patent documents to include in the comparison corpus of patent documents based in part on a comparison between prior art references cited against the target patent and prior art references cited against a potential patent document to include in the comparison corpus.

20. The system of claim 18, wherein the first module is further configured to:
select patent documents to include in the comparison corpus of patent documents based in part on a comparison between a classification of the target patent and a classification of a potential patent document to include in the comparison corpus.
